(19) United States
(12) Patent Application Publication
(10) Pub. No.: US 2013/0093393 A1
(43) Pub. Date: Apr. 18, 2013

(54) CHARGING CONTROL APPARATUS

(71) Applicants: Mitsuo Shimotani, Tokyo (JP); Makoto Mikuriya, Tokyo (JP); Takeo Sakairi, Tokyo (JP); Eriko Toma, Tokyo (JP)

(72) Inventors: Mitsuo Shimotani, Tokyo (JP); Makoto Mikuriya, Tokyo (JP); Takeo Sakairi, Tokyo (JP); Eriko Toma, Tokyo (JP)

(73) Assignee: MITSUBISHI ELECTRIC CORPORATION, Tokyo (JP)

(21) Appl. No.: 13/704,668

(22) PCT Filed: Oct. 5, 2010
(86) PCT No.: PCT/JP2010/005964

§ 371 Date: Dec. 17, 2012

(51) Int. Cl. H02J 7/00

(52) U.S. Cl. CPC H02J 7/00
USPC 320/109

(57) ABSTRACT

Disclosed is a charging control apparatus including: a communication unit 9 that communicates with a charge vehicle 3; an electric fee table 7 in which data that indicates a change of an electric fee with the elapse of time of a system power 4 is set; and a charging schedule processing unit 8 that acquires from the charge vehicle 3 a residual capacity of a battery 27 installed in the charge vehicle 3 via the communication unit 9, and plans a charging schedule to charge the battery 27 from the residual capacity of the battery 27 to a predetermined charge amount at the cheapest electric fee by a predetermined date and time, based on the electric fee table 7.

### TECHNICAL FIELD

The present invention relates to a charging control apparatus that controls charging of an electric vehicle or a hybrid electric vehicle.

### BACKGROUND ART

For a conventional charging control system that performs charging of an electric vehicle (EV) or a hybrid electric vehicle (HEV) from a home inside, there is the one disclosed in Patent Document 1, for example.

In the system, average power unit prices are calculated in real-time by an in-vehicle battery system and by a domestic battery system; based on these compared results, a power source in which the average power unit price is the cheapest is determined among a commercial power, the domestic battery of a domestic battery system, and the in-vehicle battery of an electric vehicle; and based on the determined result, electric power is distributed from the cheapest power source to the most expensive power source in the average power unit price.

Also, Patent Document 2 discloses an electric vehicle charging power management system including: a detecting means that detects electric power to a residential power load; and a control means that controls the charging power so that the sum of the power detected by the detecting means and the charging power to the battery of the electric vehicle does not exceed the tolerance of the power to be supplied from the outside to a residence.

Further, Patent Document 3 discloses a power management system that enables mutually charging of a battery of an electric vehicle by a system power and power supply from the battery of the electric vehicle to a residence side. In the system, the electric power of the battery of the electric vehicle is also supplied to the residential side, while securing the power amount required for an ordinary use of the electric vehicle is secured in the battery.

### PRIOR ART DOCUMENTS

### Patent Documents

Patent Document 1: Japanese Patent Application Publication No. 2008-141925

Patent Document 2: Japanese Patent Application Publication No. 2008-136291

Patent Document 3: Japanese Patent Publication No. 3985390

### SUMMARY OF THE INVENTION

In the prior arts represented by Patent Documents 1 and 2, out of consideration for a traveling schedule of a user of a vehicle, performed are the charging from the home inside to the electric vehicle, and the power supply from the battery of the electric vehicle to the home inside according to only the electric fee. For this reason, there is a problem such that when the user of the electric vehicle starts traveling with getting into the electric vehicle, there is a problem such that there are some cases in which a sufficient amount of charge is not secured in the corresponding electric vehicle.

Also in the prior art represented by Patent Document 3, if the charging is controlled so that the battery of the electric vehicle is always kept in a fully charged state, there are some cases such that an appropriate charge amount is not secured at the travel start of the electric vehicle, unless the electric power to be supplied from the battery of the electric vehicle to the residential side (home inside) is set to the minimum. Otherwise, if it is controlled such that the charging is carried out only by cheap electric power at a certain standard, that is, during a period of time when a unit price of the power is cheap, there is a possibility that an appropriate charge amount cannot be secured at the travel start of the electric vehicle.

The present invention is made to solve the aforementioned problems, and an object of the invention is to provide a charging control apparatus that can charge power sufficient for a travel of a vehicle at a cheap electric fee by a predetermined date and time.

A charging control apparatus according to the present invention includes: an apparatus side communication unit that communicates with a vehicle side communication unit installed in a vehicle; an electric fee table in which data indicating a change of an electric fee with the elapse of time of a system power is set; and a charging schedule processing unit that plans a charging schedule to charge a battery installed in the vehicle from a residual capacity of the battery that is acquired by the apparatus side communication unit via the communication with the vehicle side communication unit, to a predetermined charge amount at the cheapest electric fee by a predetermined date and time, based on the electric fee table, and causes a charging/recharging unit that charges the battery with the system power to control the supply of the system power to the battery in accordance with the corresponding charging schedule.

According to the invention, power sufficient for the travel of the vehicle can be charged at the cheap electric fee by the predetermined date and time.

### BRIEF DESCRIPTION OF THE DRAWINGS

FIG. 1 is a block diagram showing a configuration of a charging control system to which a charging control apparatus according to Embodiment 1 in the present invention is applied.

FIG. 2 is a flow chart showing a flow of pre-processing in charging of the charging control system in Embodiment 1.

FIG. 3 is a flow chart showing a flow of charging processing by the charging control system in Embodiment 1.

FIG. 4 is a graph for illustrating a charging control in Embodiment 1.

FIG. 5 is a block diagram showing a configuration of a charging control system to which a charging control apparatus according to Embodiment 2 in the invention is applied.

FIG. 6 is a block diagram showing a configuration of a charging control system to which a charging control apparatus according to Embodiment 3 in the invention is applied.

FIG. 7 is a block diagram showing a configuration of a charging control system to which a charging control apparatus according to Embodiment 4 in the invention is applied.

FIG. 8 is a block diagram showing a configuration of another mode of the charging control system in Embodiment 4.

FIG. 9 is a block diagram showing a configuration example of a charging control system to which a charging control apparatus according to Embodiment 5 in the invention is applied.

FIG. 10 is a block diagram showing a configuration example of a charging control system to which a charging control apparatus according to Embodiment 6 in the invention is applied.

FIG. 11 is a flow chart showing a flow of processing by a charging/discharging unit in Embodiment 6.

FIG. 12 is a flow chart showing a flow of processing by a navigation server apparatus in Embodiment 6.

FIG. 13 is a flow chart showing a flow of processing by a charging control server apparatus in Embodiment 6.

FIG. 14 is a block diagram showing a configuration of a charging control system to which a charging control apparatus according to Embodiment 7 in the invention is applied.

FIG. 15 is a graph for illustrating a charging control 1 in Embodiment 7.

FIG. 16 is a graph for illustrating a charging control 2 according to Embodiment 7.

### BEST MODE FOR CARRYING OUT THE INVENTION

In the following, in order to explain the present invention in more detail, the best mode for carrying out the invention will be described in accordance with the accompanying drawings. Embodiment 1.

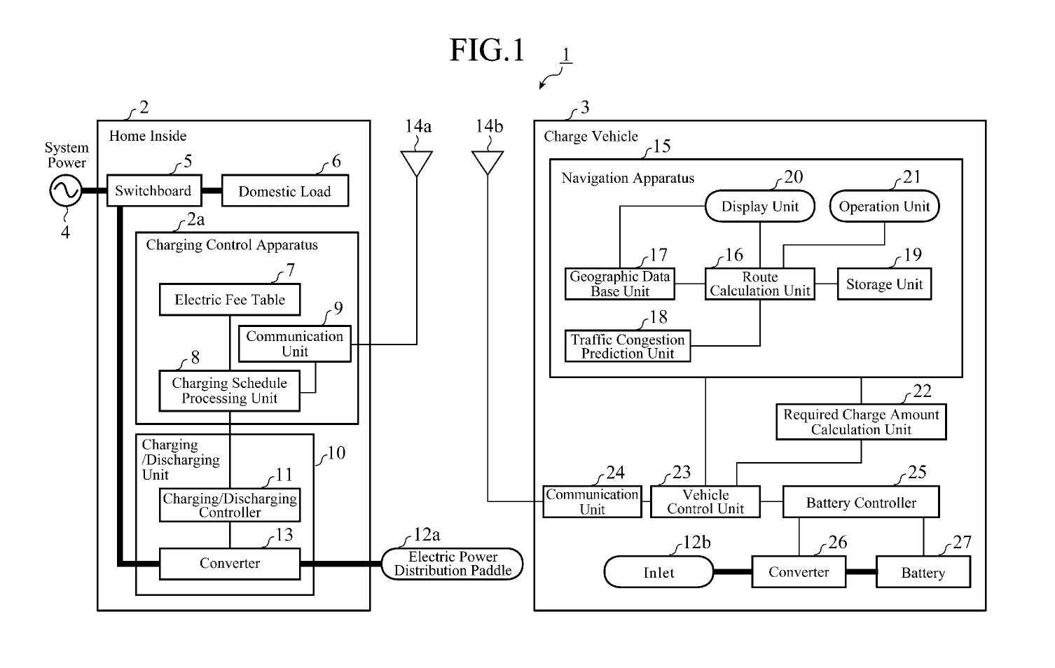

FIG. 1 is a block diagram showing a configuration of a charging control system to which a charging control apparatus according to Embodiment 1 in the present invention is applied, and shows a system to carry out dielectric charging. In FIG. 1, in a home inside 2 of the charging control system 1, a system power 4 from a power company is connected to a domestic load 6 and a charging/discharging unit 10 via a switchboard 5. A battery 27 of a charge vehicle 3 is charged with the power of the system power 4, or power of the battery 27 is supplied to the home inside 2. A charging control apparatus 2a for controlling the charging of the charge vehicle 3 is connected to the charging/recharging unit 10.

The charging control apparatus 2a is an apparatus to control the charging/discharging of the charging/discharging unit 10, and has an electric fee table 7, a charging schedule processing unit 8 and a communication unit 9. Hereupon, data that indicates the change of an electric fee of the system power 4 with the elapse of time is set in the electric fee table 7. Further, the charging schedule processing unit 8 is a constitutional part to plan a charging schedule to charge the battery 27 to a predetermined charge amount at the cheapest fee by a departure date and time of the charge vehicle 3 with the electric fee data predicted from the electric fee table 7 based on the charging state of the battery 27. Furthermore, the communication unit 9 is a constitutional part to communicate with the charge vehicle 3 side via an antenna 14a, and acquires from the charge vehicle 3 side the charge state of the battery 27 of the charge vehicle on the departure date and time, or on the charging.

The charging/discharging unit 10 is an apparatus to supply power of the system power 4 to the charge vehicle 3 via an electric power distribution paddle 12a, and contrarily supply power from the charge vehicle 3 to the home inside 2, and has a charging/discharging controller 11 and a converter 13. The charging/discharging controller 11 is a controller to control the converter 13 in accordance with an instruction from the charging schedule processing unit 8 of the charging control apparatus 2a, and supplies the system power 4 to the charge vehicle 3 or supplies power from the charge vehicle 3 to the home inside 2. The converter 13 is connected to the switchboard 5 and the electric power distribution paddle 12a, and performs AC-to-high frequency AC conversion if the battery 27 of the charge vehicle 3 is charged with the system power 4, or performs high frequency AC-to-AC conversion if the power is supplied (discharged) from the battery 27 to the home inside 2 side, in accordance with the instruction from the charging/discharging controller 11. The electric power distribution paddle 12a is a constitutional part that performs an electromagnetic induction-based power transfer with an inlet 12b on the charge vehicle 3 side, and has one coil constructing a transformer in combination with the inlet 12b. Needless to say, during the electromagnetic induction, a step-up or step-down operation is carried out based on the winding ratio of the coils, and the winding ratio is set to an appropriate ratio for both of the home inside 2 and the charge vehicle 3 side.

A navigation apparatus 15, a required charge amount calculation unit 22, a battery 27 that is a power source of the charge vehicle 3, and a vehicle control unit 23, a communication unit 24, a battery controller 25 and a converter 26 that are constitutional parts to charge/discharge the battery 27 are installed in the charge vehicle 3. The navigation apparatus 15 is an apparatus to perform navigation processing for the charge vehicle 3, and has a route calculation unit 16, a geographic data base unit 17, a traffic congestion prediction unit 18, a storage unit 19, a display unit 20 and an operation unit 21.

The route calculation unit 16 has a position measuring function, and is a constitutional part to calculate a route for the vehicle to travel, based on the position measurement result of the vehicle, geographic data in the peripheral area of the vehicle acquired from the geographic data base unit 17 and a destination that is set using the operation unit 21. The geographic data base unit 17 is a data base to store the geographic data. The traffic congestion prediction unit 18 is a constitutional part to store past traffic congestion information based on the time and/or the day of the week, and predict the traffic congestion state of the road that the vehicle is on travel. The storage unit 19 is a storage unit to store information such as a route calculation result by the route calculation unit 16 and/or a destination used for this calculation, and a departure date and time of the vehicle. Specifically, a non-volatile memory of which the storage content is not deleted is used for the storage unit 19 even if power of the navigation apparatus 15 is turned OFF. The display unit 20 is a display device of the navigation apparatus 15. The operation unit 21 is a constitutional part to input and set information to the navigation apparatus 15 through user operations, and may be a touch panel installed in the display unit 20, for example.

The required charge amount calculation unit 22 is a constitutional part to calculate a charge amount required for traveling the corresponding route from the information regarding the scheduled travel route of the vehicle read from the storage unit 19. It is noted that the required charge amount calculation unit 22 and the vehicle control unit 23 (mentioned later) are functional configurations to be achieved such that a microcomputer of an electronic control unit (ECU), installed separately from the navigation apparatus 15, for controlling the electric system of the charge vehicle 3 executes programs for control.

The vehicle control unit 23 is a constitutional part to perform an electric control within the charge vehicle 3. Also, the communication unit 24 to communicate with the charging control apparatus 2a in the home inside 2 is connected to the vehicle control unit 23. If the vehicle control unit 23 acquires information such as a current used for the battery 27 on charge and a residual capacity of the battery 27 as information indicating the charging state of the battery 27 from the battery controller 25, the unit transmits the information to the charging control apparatus 2a via the communication unit 24.

Further, if the calculation result of the power amount required for a scheduled travel route of the vehicle is acquired from the required charge amount calculation unit 22 of the navigation apparatus 15, the vehicle control unit 23 transmits the calculation result to the charging control apparatus 2a via the communication unit 24. It is noted that the communication unit 24 communicates with the charging control apparatus 2a via the antenna 14b.

For a communication system in the communication units 9 and 24, not especially determined, a portable telephone, a wireless local area network (LAN), ZigBEE® (registered trademark), Bluetooth®, and dedicated short range communication (DSRC), for example, can be used. Also, a 5.8 GHz band communication apparatus, including an in-vehicle ETC®, may be used for the communication units 9 and 24. Further, as not illustrated, the communication may be achieved by superimposing communication signals onto a high frequency AC with a controller as a communication unit to perform power line communication (PLC) that is interconnected via a power line, without using the antennas 14a and 14b.

The battery controller 25 is a constitutional part to control charging/discharging of the battery 27. Specifically, if a charging/discharging control signal is received from the charging control apparatus 2a via the vehicle control unit 23, the battery controller 25 controls the converter 26 according to the charging/discharging control signal with monitoring the residual capacity of the battery 27 to thereby charge/discharge the battery 27. The converter 26 is a constitutional part to convert high frequency AC power that is input via the inlet 12b into DC power, or to convert DC power charged in the battery 27 into high frequency AC power. The inlet 12b is a constitutional part to transfer power by electromagnetic induction with the electric power distribution paddle 12a in the home inside 2, and has another coil constructing a transformer in combination with the electric power distribution paddle 12a.

The power input from the system power 4 is used for the domestic load 6 via the switchboard 5.

Hereupon, in the case where the battery 27 of the charge vehicle 3 is charged by the system power 4 (charging), the converter 13 converts the power of the system power 4 input via the switchboard 5 into high frequency AC power. This high frequency AC power is supplied to a converter 26 on the charge vehicle 3 side by the dielectric function between the electric power distribution paddle 12a and the inlet 12b. The converter 26 converts the high frequency AC power input via the inlet 12b into DC power, and charges the battery 27.

On the other hand, in the case where power is supplied from the charge vehicle 3 to the home inside 2 (feeding), the charging/discharging controller 11 converts the power that is input via the electric power distribution paddle 12a into a domestic power frequency and feeds the power to the switchboard 5, based on an instruction of the charging schedule processing unit 8, to be used in the domestic load 6.

Next, an operation thereof will be described.

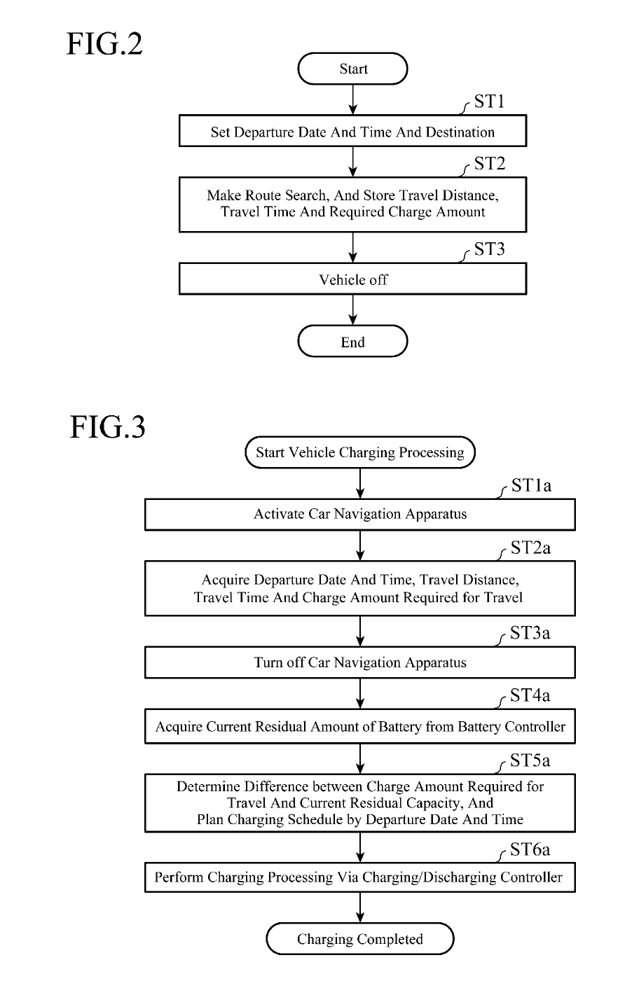

FIG. 2 is a flow chart showing a flow of pre-processing in charging by the charging control system in Embodiment 1, and shows operation on the charge vehicle 3 side in preliminary steps in the charging.

First, based on the route setting screen displayed on the display unit 20 of the navigation apparatus 15, a user sets a departure date and time and a destination using the operation unit 21 (step ST1). The departure date and time and the destination are stored in the storage unit 19 by the route calculation unit 16.

Then, the route calculation unit 16 searches the scheduled travel route of the vehicle based on the position measurement result of the vehicle, the geographic data acquired from the geographic data base unit 17, and the destination point that is set using the operation unit 21.

At this time, the route calculation unit 16 calculates the travel distance of the scheduled travel route and the travel time required for the vehicle to travel on this route, and stores the resultant in the storage unit 19.

In addition, an average power consumption amount (KWh/Km) of the battery 27 per unit travel distance of the charge vehicle 3, for example, is set in the required charge amount calculation unit 22, and the required charge amount calculation unit 22 calculates the power amount (KWh) required for a travel on the corresponding route by multiplying the travel distance (Km) on the scheduled travel route that is stored in the storage unit 19 by the power consumption amount (KWh/Km), and stores the resultant in the storage unit 19 as a charge amount required for the vehicle to normally travel the route. The processing thus far corresponds to step ST2.

Thereafter, if the user performs the OFF operation of the electric system of the vehicle, the vehicle control unit 23 turns the power supply of the power system of the charge vehicle 3 OFF (step ST3).

FIG. 3 is a flow chart of the charging processing by the charging control system in Embodiment 1. First, if the communication unit 9 establishes a communication connection with the communication unit 24 of the charge vehicle 3, the charging schedule processing unit 8 of the charging control apparatus 2a transmits an activation instruction of the navigation apparatus 15 via the communication unit 9. In response to the activation instruction received from the charging schedule processing unit 8 via the communication unit 24, the vehicle control unit 23 supplies power to the navigation apparatus 15 to thus activate the navigation apparatus 15 (step ST1a).

Then, the charging schedule processing unit 8 transmits, via the communication unit 9, an acquisition request for the departure date and time, a travel distance of the scheduled travel route, a travel time on the corresponding route, and a charge amount required to normally travel the corresponding route that are set in the navigation apparatus 15. If the acquisition request is received from the charging schedule processing unit 8 via the communication unit 24, the vehicle control unit 23 reads the departure date and time, the travel distance of the scheduled travel route, the travel time on the corresponding route, and the charge amount required to normally travel the corresponding route from the storage unit 19 accordingly, and transmits the resultant to the charging control apparatus 2a via the communication unit 24. The charging schedule processing unit 8 acquires, via the communication unit 9, the departure date and time of the charge vehicle 3, the travel distance of the scheduled travel route, the travel time on the corresponding route, and the charge amount required to normally travel the corresponding route (step ST2a).

Subsequently, the charging schedule processing unit 8 transmits an OFF instruction to the navigation apparatus 15 OFF via the communication unit 9. If the OFF instruction is received from the charging schedule processing unit 8 via the communication unit 24, the vehicle control unit 23 turns the power supply to the navigation apparatus 15 OFF accordingly (step ST3a).

After this, the vehicle control unit 23 acquires information to indicate the current charging state such as the residual capacity of the battery 27 from the battery controller 25, and transmits the information to the charging schedule processing unit 8 via the communication unit 24. The charging schedule processing unit 8 acquires the current charge amount (residual capacity) of the battery 27 via the communication unit 9 (step ST4a).

If the departure date and time, the travel distance of the scheduled travel route, the travel time on the route, the charge amount required for normally traveling the corresponding route, and the current charge amount of the battery 27 are acquired, the charging schedule processing unit 8 calculates the difference between the charge amount required for the vehicle to normally travel the corresponding route and the current charge amount, and plans a charging schedule to reach the charge amount required for the above travel by the departure date and time using the electric fee prediction data in the electric fee table 7 (step ST5a).

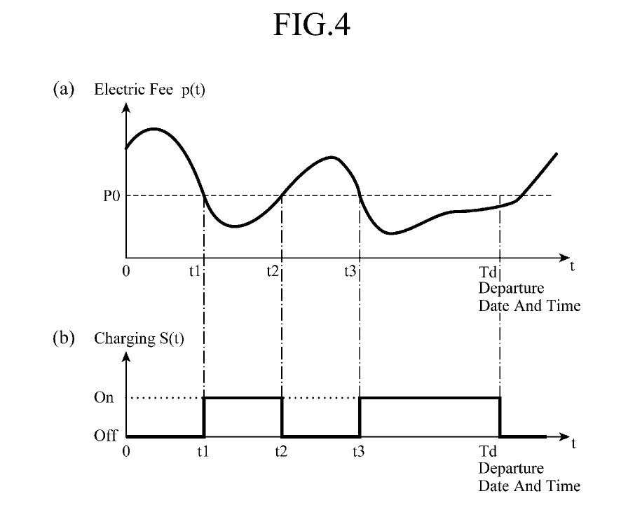

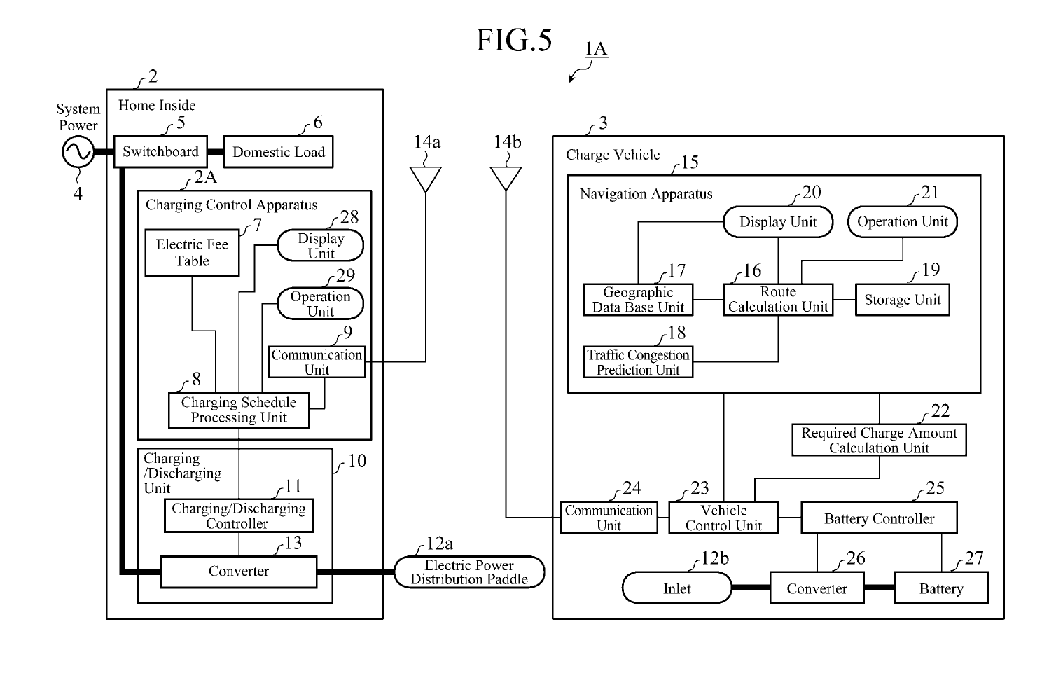

FIG. 4 is a graph for illustrating the charging control in Embodiment 1, where FIG. 4(a) shows the electric fee prediction data in the electric fee table 7, and FIG. 4(b) shows an ON/OFF control signal in the charging that is output in accordance with the charging schedule. In Embodiment 1, a charge amount required for the travel of the travel distance of the scheduled travel route, for example, 100 Km, is used to plan the charging schedule. Also, an electric fee p (t) of the feeding power in the electric fee table 7 is expressed by a curve shown in FIG. 4(a), where t=0 is the current time, and t=Td is the departure date and time of the charge vehicle 3.

Hereupon, it is assumed that a charging time T required for charging from the current residual capacity H0 of the battery 27 (a charge amount of the battery 27 upon start of the charging control) to a charge amount Hd required for the travel on the above scheduled travel route (a charge amount to be targeted) is T=(Hd−H0)/W. In this case, a relationship of T=(Hd−H0)/W<Td must be satisfied to complete the charging by the departure date and time Td when the charging start time is set to zero. However, W is a charge amount per unit time.

The charging schedule processing unit 8 determines a charging ON time when the charging is performed, and a charging OFF time when the charging is not performed in a period from the current time to the departure date and time Td, using the electric fee prediction data curve p (t) in the electric fee table 7 and a threshold P0 of the electric fee shown in FIG. 4(a).

Concretely, the charging is turned ON by the charging control signal S (t)=1 in a period where p (t)≦P0, and is turned OFF by the charging control signal S (t)=0 in a period where p (t)>P0.

At this time, the charging schedule processing unit 8 calculates a value of P0 such that ∫S (t) dt (t=0 to Td) in which the charging control signal S (t) is time-integrated becomes ∫s (t) dt=charging time T.

In the example in FIG. 4(b), the charging is ON, that is, S (t)=1 is maintained, when t1≦t<t2 and t3≦t<Td, and the charging is OFF, that is, S (t)=0 is maintained in the other periods of time. In this case, the charging time T is T=(t2−t1)+(Td−t3).

When the above charging schedule is planned, the battery 27 can be charged with sufficient power at a cheap electric fee and at the travel start by the departure date and time of the charge vehicle 3.

To return to the illustration of FIG. 3, as stated above, if the charging schedule in which the periods for switching the value of the charging control signal are designated, determined as stated above, is planned, the charging schedule processing unit 8 transmits an instruction for instructing the charging control in accordance with the corresponding charging schedule to the charging/discharging controller 11. Based on the instruction received from the charging schedule processing unit 8, the charging/discharging controller 11 performs the charging processing for the battery 27 in accordance with the above charging schedule (step ST6a).

As described above, according to the present Embodiment 1, the charging control apparatus 2a includes: the communication unit 9 that communicates with the communication unit 24 installed in the charge vehicle 3; the electric fee table 7 in which the data representing the change of the electric fee with the elapse of time of the system power 4 is set; and the charging schedule processing unit 8 that acquires a residual capacity of the battery 27, which is installed in the charge vehicle 3, from the corresponding charge vehicle 3 via the communication unit 9, plans a charging schedule to charge the battery 27, which is installed in the charge vehicle 3, from the residual capacity H0 to the required charge amount Hd at the cheapest electric fee by the departure date and time, based on the electric fee table 7, and causes the charging/discharging unit 10 that charges the battery 27 with the system power 4 to supply the system power 4 to the battery 27 in accordance with the corresponding charging schedule. With the above configuration, the battery 27 can be charged with sufficient power at the travel start and at a cheap electric fee by the departure date and time of the charge vehicle 3.

Incidentally, though in the above Embodiment 1 the charge amount Hd required for the travel and the charging time T required for this charging are calculated based on the travel distance of the scheduled travel route and the average power consumption amount, the charge amount Hd and the charging time T may be calculated using the detailed information about the route.

For example, the charge amount Hd required for the travel of the scheduled travel route may be calculated using the undulation information of the road.

In this case, the route calculation unit 16 calculates the scheduled travel route using the road network data of the geographic data and the undulation information of the road stored in the geographic data base unit 17, and stores the route of the calculation result, undulation information thereof, and so on in the storage unit 19. The required charge amount calculation unit 22 estimates the power consumption amount related to a slope of the road, using the undulation information of the scheduled travel route stored in the storage unit 19.

Hereupon, in the case of a slope from a low spot to a high spot on the route, it is determined that the power consumption amount is higher than a flat route and the required charge amount therefor is also high, and in the case of a slope from a high spot to a low spot to the contrary, it is determined that the power consumption amount is lower than a flat route since charging due to regenerative braking is expected, and the required charge amount therefor is also low.

Specifically, the power consumption amount of the battery 27 according to the slope information of the road is preset in the required charge amount calculation unit 22; when the charge amount Hd is calculated as in the above Embodiment 1, the power consumption amount of the corresponding block is calculated according to the slope of the undulation of the scheduled travel route, and the total power consumption amount in the case where the corresponding scheduled travel route is traveled is corrected. When the charge amount Hd and the charging time T is determined from the thus calculated power consumption amount in the same manner as the above Embodiment 1, a charging control allowing for actual road conditions can be performed.

In addition, the charge amount Hd required for the travel on the scheduled travel route may be calculated using a predicted vehicle speed to be specified from a road classification. For example, the route calculation unit 16 specifies the classification of the road from the geographic data, and also stores the road classification in the scheduled travel route in the storage unit 19. The required charge amount calculation unit 22 predicts the power consumption amount related to the vehicle speed, using a predicted vehicle speed specified from the road classification in the scheduled travel route stored in the storage unit 19.

In this case, it is determined that the power consumption amount is higher in a highway on the route than that in an ordinary road. Specifically, the power consumption amount of the battery 27 corresponding to the traveling speed of the charge vehicle 3 is preset in the required charge amount calculation unit 22; when the charge amount Hd is calculated in the same manner as the above Embodiment 1, the power consumption amount of the corresponding block is calculated according to the predicted vehicle speed specified from the road classification of the scheduled traveling road, and the total power consumption amount in the case where the corresponding scheduled travel route is traveled is corrected. From the thus calculated power consumption amount, the charge amount Hd and the charging time T is determined in the same manner as the above Embodiment 1, and therefore a charging control allowing for actual road conditions can be performed. It is noted that the charge amount Hd may be calculated in combination with the above mentioned undulation information of the route.

Further, the charge amount Hd required for the travel on the scheduled travel route may be calculated using the traffic congestion prediction data stored in the traffic congestion prediction unit 18.

For example, for some roads, regular traffic congestion information to a degree can be acquired depending on the day of the week.

Therefore, if the scheduled travel route is calculated by the route calculation unit 16, the traffic congestion prediction unit 18 acquires the traffic congestion prediction data in the road on the corresponding route from the departure date and time, and stores the resultant in the storage unit 19 as information about the scheduled travel route.

In the required charge amount calculation unit 22, a power consumption amount of the battery 27 according to the traveling speed of the charge vehicle 3 is preset; when the charge amount Hd is calculated in the same manner as the above Embodiment 1, with respect to a block in which the traffic congestion on the scheduled travel route is expected, the power consumption amount is corrected such that an excess time generated by the traffic congestion, that is, a drop in the traveling speed, is taken into consideration in addition to the travel time in the case where the corresponding block is traveled at an average vehicle speed

When the charge amount Hd and the charging time T are determined from the thus calculated power consumption amount in the same manner as the above Embodiment 1, a charging control allowing for actual road conditions can be performed.

Additionally, the charge amount Hd may be calculated such that the above mentioned undulation information of the route and the vehicle speed are combined with each other.

The above mentioned calculating method of the required charge amount Hd can be applied to any one of Embodiment 2 to Embodiment 7 described later, in addition to Embodiment 1.

### Embodiment 2

FIG. 5 is a block diagram showing a configuration of a charging control system to which a charging control apparatus according to Embodiment 2 in the invention is applied. In FIG. 5, a charging control apparatus 2A in a home inside 2 of a charging control system 1A has a display unit 28 and an operation unit 29, and provides a human machine interface (HMI) for route setting that sets a departure date and time and a destination of a charge vehicle 3.

First, the charging control apparatus 2A displays an operation screen to operate a navigation apparatus 15 on the display unit 28. An activation button (software button) to activate the navigation apparatus 15 of the charge vehicle 3 is arranged on the operation screen.

In this connection, if a user operates the corresponding activation button using the operation unit 29, a communication unit 9 establishes a connection to communicate with a communication unit 24 of the charge vehicle 3. In this manner, the charging control apparatus 2A transmits an activation signal to the charge vehicle 3 side via the communication unit 9. If the activation signal from the charging control apparatus 2A is received via the communication unit 24, the vehicle control unit 23 of the charge vehicle 3 activates the navigation apparatus 15, and also transmits the route setting screen data of the navigation apparatus 15 to the charging control apparatus 2A. The charging control apparatus 2A displays the route setting screen of the navigation apparatus 15 on the display unit 28.

Then, if the user performs an input operation of the departure date and time and the destination based on the above route setting screen, the charging control apparatus 2A transmits the departure date and time and the destination to the charge vehicle 3 via the communication unit 9. If the departure date and time and the destination are received from the charging control apparatus 2A via the communication unit 24, the vehicle control unit 23 outputs these to the navigation apparatus 15 such that a route search and a calculation for a required charge amount Hd are executed.

As mentioned above, when the user sets the departure date and time and the destination by a remote operation via the communication units 9 and 24 as mentioned above, the route calculation unit 16 searches a scheduled travel route that is defined by the position measurement result of the vehicle and the destination set by the user, and stores the scheduled travel route of the searched result, and the travel distance and the travel time thereof in the storage unit 19.

Also, the required charge amount calculation unit 22 calculates the power consumption amount required for the travel on the corresponding route from the travel distance of the scheduled travel route calculated by the route calculation unit 16 and an average power consumption amount of the vehicle.

Further, the required charge amount calculation unit 22 corrects the power consumption amount of the calculated result according to the road conditions that are predicted at the departure date and time set by the user, in the same manner as the above Embodiment 1, and calculates the charge amount Hd required for the travel on the corresponding route, and stores the resultant in the storage unit 19. Thereafter, the vehicle control unit 23 turns OFF the power supply to the navigation apparatus 15.

Hereinafter, as in the processing illustrated in the above Embodiment 1 with reference to FIG. 3, the charging control apparatus 2A plans a charging schedule that enables to charge the battery 27 with sufficient power at the travel start and at a cheap electric fee by the departure date and time set by the user. Thereafter, the charging for the battery 27 is carried out in accordance with this charging schedule in the same manner as the above Embodiment 1.

Incidentally, shown in the above description is the case where the user inputs the departure date and time using the operation unit 29 after activation of the navigation apparatus 15; however, it may be configured such that when the user inputs the departure date and time in the charging control apparatus 2A using the operation unit 29 without activating the navigation apparatus 15, the charging control apparatus 2A acquires the charge amount Hd calculated by the required charge amount calculation unit 22 by the remote operation, and plans the charging schedule.

As described above, according to the present Embodiment 2, the charge vehicle 3 includes: the navigation apparatus 15 having a geographic data base unit 17 that stores geographic data, and the route calculation unit 16 that calculates the scheduled travel route to the destination based on the geographic data and the vehicle position read from the geographic data base unit 17; and the required charge amount calculation unit 22 that calculates a required charge amount Hd for the charge vehicle 3 to travel the corresponding scheduled travel route based on the travel distance of the scheduled travel route calculated by the route calculation unit 16 and a power consumption amount of the battery 27 per unit travel distance of the charge vehicle 3, wherein the charging schedule processing unit 8 requests the charge vehicle 3, via the communication unit 9, to search the route to the destination that is input using the operation unit 29 to perform the input operation, and thereby the route calculation unit 16 calculates a scheduled travel route to the destination, and the required charge amount calculation unit 22 calculates the required charge amount Hd for the corresponding scheduled travel route, and acquires the required charge amount Hd and a residual capacity H0 of the battery 27 from the charge vehicle 3 via the communication unit 9, and plans a charging schedule for charging the battery 27 from the residual capacity H0 of the battery 27 to the required charge amount Hd at the cheapest electric fee by the travel start date and time of the charge vehicle 3, based on the electric fee table 7. As mentioned above, when the remote operation to communicate with the charge vehicle 3 via the communication unit 9 is performed, the scheduled travel route of the charge vehicle 3 from the home inside 2 side is set; thus, the charging schedule can be planned such that the battery 27 is charged with sufficient power for the travel at the cheapest electric fee by the departure date and time.

### Embodiment 3

In Embodiment 3, a navigation function is provided to a charging control apparatus provided in a home inside, and therefore even a charge vehicle not equipped with a navigation apparatus is considered as a target for planning a charging schedule.

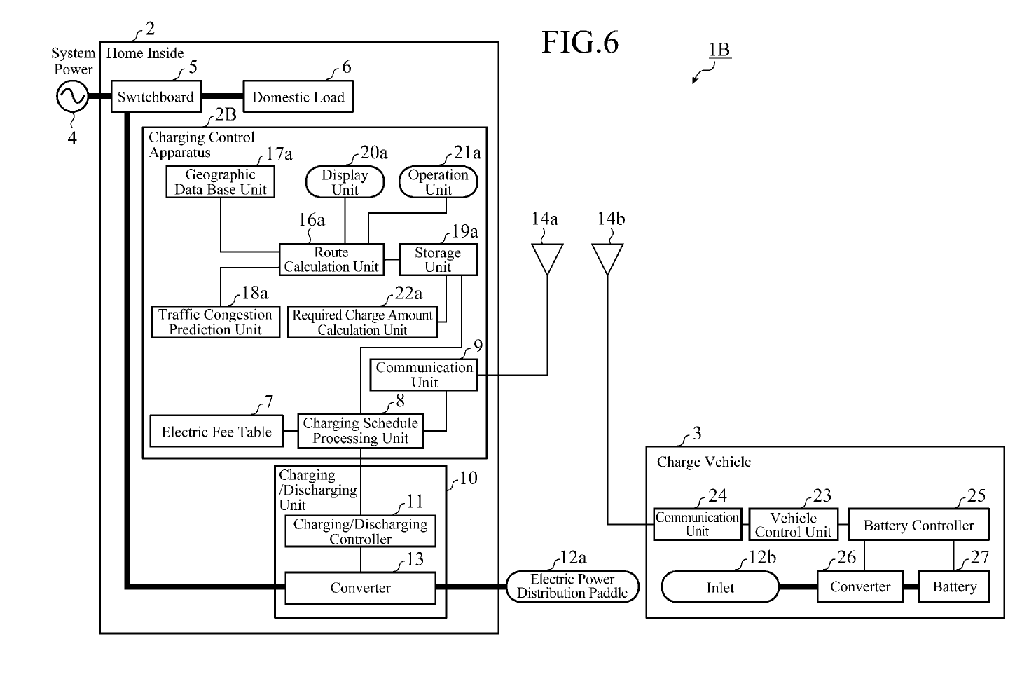

FIG. 6 is a block diagram showing a configuration of a charging control system to which a charging control apparatus according to Embodiment 3 in the invention is applied. In FIG. 6, a charging control apparatus 2B in a home inside 2 of a charging control system 1B includes a route calculation unit 16a, a geographic data base unit 17a, a traffic congestion prediction unit 18a, a storage unit 19a, a display unit 20a and an operation unit 21a as a configuration to execute navigation processing, and includes an electric fee table 7, a charging schedule processing unit 8, a communication unit 9 and a required charge amount calculation unit 22a as a configuration to execute a charging control.

The route calculation unit 16a is a constitutional part to calculate a route in which a charge vehicle 3 travels, based on the position information of the charge vehicle 3, geographic data including a peripheral area of the charge vehicle 3 acquired from the geographic data base unit 17a, and a destination that is set using the operation unit 21a. The geographic data base unit 17a is a data base to store the geographic data. The traffic congestion prediction unit 18a is a constitutional part to store the traffic congestion information in the past depending on the time and the day of the week as in the above Embodiment 1, and to predict the traffic congestion state of a road on which the charge vehicle 3 travels, based on the traffic congestion information in the past.

The storage unit 19a is a storage unit to store a route calculation result by the route calculation unit 16a, information such as a destination used for the calculation, and a departure date and time of the vehicle. The display unit 20a is a display device of the charging control apparatus 2B. The operation unit 21a is a constitutional part for the user to input and set information in the charging control apparatus 2B, and may be a touch panel, for example, installed in the display unit 20a.

The required charge amount calculation unit 22a is a constitutional part to calculate a charge amount Hd required for traveling the corresponding route from the information about the scheduled travel route of the vehicle read from the storage unit 19a.

For instance, the charging control apparatus 2B may have a configuration having the same function as the navigation apparatus 15 in Embodiment 1. Or, a personal digital assistant (PDA) that executes an installed navigation application to perform navigation processing, or a portable navigation device (PND) that can be attached to or detached from the charge vehicle 3 may be used. Or, a portable telephone terminal that performs navigation processing by executing a downloaded navigation application may be used. In the case of the portable telephone terminal, geographic data base (DB) and traffic congestion prediction data may be acquired from an external information providing server that is connected via the Internet (not illustrated). However, in FIG. 6, components that are the same as or equivalent to those in FIG. 1 are denoted by the same reference symbols, and descriptions thereof will be omitted.

Next, an operation thereof will be described.

First, the charging control apparatus 2B provides an HMI for route setting of the charge vehicle 3. Specifically, the route calculation unit 16a of the charging control apparatus 2B displays a route setting screen of the charge vehicle 3 on the display unit 20a. Based on the route setting screen, a user inputs the departure date and time, the departure place (current position of the charge vehicle 3), and the destination using the operation unit 21a.

The route calculation unit 16a searches for a scheduled travel route to be defined by the departure place and the destination set by the user, and stores the scheduled travel route of the searched result, the travel distance and travel time thereof in the storage unit 19a. Also, the required charge amount calculation unit 22a calculates the power consumption amount required for the travel on the corresponding route from the travel distance of the scheduled travel route calculated by the route calculation unit 16a and an average power consumption amount of the vehicle.

Further, the required charge amount calculation unit 22a corrects the calculated power consumption amount according to road conditions that are predicted on the departure date and time set by the user, in the same manner as the above Embodiment 1, calculates the charge amount Hd required for the travel on the corresponding route, and stores the resultant in the storage unit 19a. Thereafter, the communication unit 9 establishes a connection for communication with the communication unit 24 of the charge vehicle 3.

Then, the charging schedule processing unit 8 inquires a current residual capacity H0 of the battery 27 to the vehicle control unit 23 via the communication unit 9. Responding to the above inquiry from the charging schedule processing unit 8, the vehicle control unit 23 acquires the residual capacity H0 of the battery 27 from the battery controller 25, and transmits the resultant to the charging schedule processing unit 8 via the communication unit 24. The charging schedule processing unit 8 acquires the residual capacity H0 of the battery 27 via the communication unit 9.

Subsequently, if the current residual capacity H0 of the battery 27 is acquired from the charge vehicle 3, the charging schedule processing unit 8 reads the departure date and time, the travel distance of the scheduled travel route, the travel time in the corresponding route, and the required charge amount Hd from the storage unit 19a, calculates the difference between the charge amount Hd and the residual capacity H0, and plans a charging schedule to reach the charge amount Hd by the departure date and time, using the electric fee prediction data in the electric fee table 7, in the same manner as the above Embodiment 1.

Thereafter, the charging schedule processing unit 8 transmits an instruction for instructing a charging control in accordance with the charging schedule planned as mentioned above to the charging/discharging controller 11. In this manner, the charging processing for the battery 27 in accordance with the above charging schedule is performed via the charging/discharging controller 11.

As described above, according to the present Embodiment 3, there is provided with the charging control apparatus 2B as an apparatus in the home inside 2, including: the electric fee table 7 in which data indicating a change of an electric fee with the elapse time of the system power 4 is set; the route calculation unit 16a that calculates the scheduled travel route to the destination based on the geographic data read from the geographic data base 17a and the position of the charge vehicle 3; the required charge amount calculation unit 22a that calculates the required charge amount Hd for the charge vehicle 3 to travel the corresponding scheduled travel route based on the travel distance of the scheduled travel route calculated by the route calculation unit 16a and the power consumption amount per unit travel distance of the battery 27 installed in the charge vehicle 3; and the charging schedule processing unit 8 that acquires the residual capacity H0 of the battery 27 from the charge vehicle 3 via the communication unit 9, plans a charging schedule to charge the battery 27 from the residual capacity H0 of the battery 27 to the required charge amount Hd at the cheapest electric fee by the departure date and time, based on the electric fee table 7, and causes the charging/discharging unit 10 that charges the battery 27 with the system power 4 to supply the system power 4 to the battery 27 in accordance with the corresponding charging schedule.

With the above configuration, the scheduled travel route of the charge vehicle 3 can be set from the home inside 2, and the charging control thereof can be performed. Therefore, for a even vehicle not having a navigation apparatus, a charging schedule to charge the battery 27 with sufficient power for the travel at the cheapest electric fee by the departure date and time can be planned.

### Embodiment 4

In Embodiment 4, a charging control function is provided to a navigation apparatus installed in a charge vehicle, and therefore the charging schedule is planned from the navigation apparatus side.

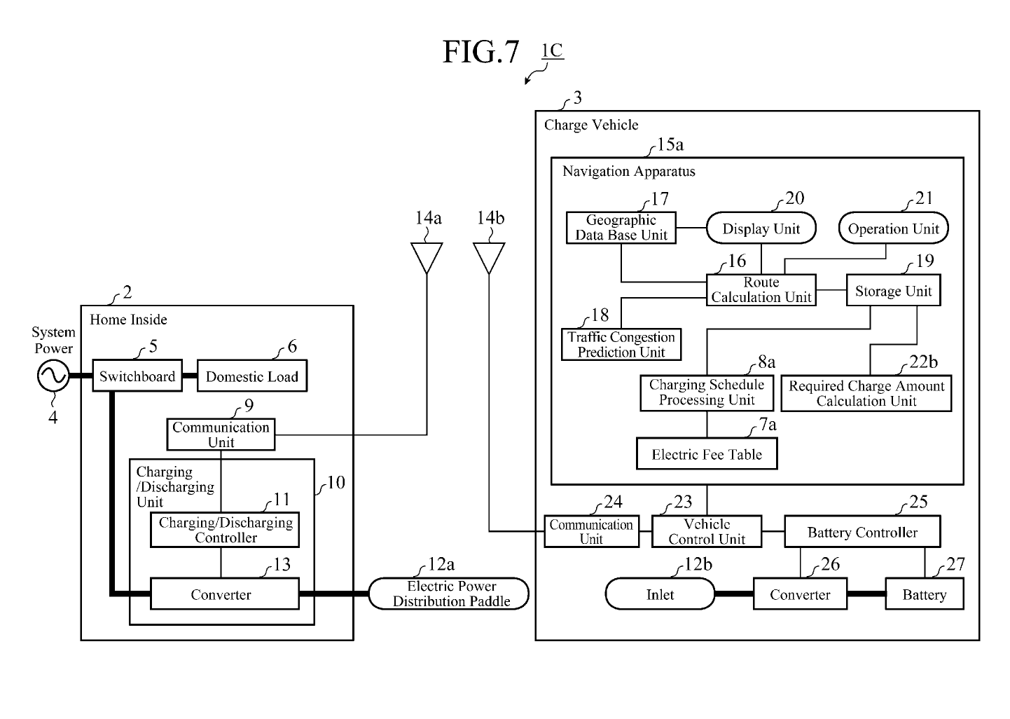

FIG. 7 is a block diagram showing a configuration of a charging control system to which a charging control apparatus according to Embodiment 4 in the invention is applied. In FIG. 7, a navigation apparatus 15a of a charging control system 1c has a route calculation unit 16, a geographic data base unit 17, a traffic congestion prediction unit 18, a storage unit 19, a display unit 20, and an operation unit 21 as a configuration to execute navigation processing, and has an electric fee table 7a, a charging schedule processing unit 8a and a required charge amount calculation unit 22b as a configuration to perform a charging control.

The electric fee table 7a is data to indicate a change of an electric fee with the elapse of time, and is stored in a memory (not illustrated) or a storage unit 19 in the navigation apparatus 15a. Also, the charging schedule processing unit 8a is a constitutional part to plan a charging schedule to charge the battery 27 to a predetermined charge amount at the cheapest fee by a departure date and time of the charge vehicle 3, by using the electric fee prediction data to be specified from the electric fee table 7a, based on the charging state of the battery 27. The required charge amount calculation unit 22b is a constitutional part to calculate a charge amount Hd required for traveling the corresponding route based on the information about the scheduled travel route of the charge vehicle 3 read from the storage unit 19.

However, in FIG. 7, components that are the same as or equivalent to those in FIG. 1 are denoted by the same reference symbols, and descriptions thereof will be omitted.

The route calculation unit 16, the geographic data base unit 17, the traffic congestion prediction unit 18, the storage unit 19, the display unit 20, the operation unit 21, the electric fee table 7a, the charging schedule processing unit 8a and the required charge amount calculation unit 22b has a functional configuration that is achieved, for example, in such a manner that a microcomputer installed in the navigation apparatus 15a executes a program for control.

Next, an operation thereof will be described.

In this case, an operation related to the charging control of the charge vehicle 3 will be described.

First, the navigation apparatus 15a provides an HMI for route setting of the charge vehicle 3. Specifically, the route calculation unit 16 of the navigation apparatus 15a displays a route setting screen of the charge vehicle 3 on the display unit 20. Based on the route setting screen, a user inputs a departure date and time, a departure place (current position of the charge vehicle 3), and a destination using the operation unit 21.

The route calculation unit 16 searches for a scheduled travel route defined by the departure place and the destination set by the user, and stores the scheduled travel route of the searched result and the travel distance and travel time thereof in the storage unit 19. Also, the required charge amount calculation unit 22b calculates the power consumption amount required for the travel on the corresponding route from the travel distance of the scheduled travel route calculated by the route calculation unit 16 and the average power consumption amount of the vehicle.

Further, the required charge amount calculation unit 22b corrects the calculated power consumption amount according to the road conditions that are predicted on the departure date and time set by the user, in the same manner as the above Embodiment 1, calculates the charge amount Hd required for the travel on the corresponding route, and stores the resultant in the storage unit 19.

Then, the charging schedule processing unit 8a inquires the current residual capacity of the battery 27 to the vehicle control unit 23. Responding to the inquiry from the charging schedule processing unit 8a, the vehicle control unit 23 acquires the residual capacity H0 of the battery 27 from the battery controller 25, and outputs the resultant to the charging schedule processing unit 8a.

Subsequently, if the current residual capacity H0 of the battery 27 is acquired, the charging schedule processing unit 8a reads the departure date and time, the travel distance of the scheduled travel route, the travel time on the corresponding route and the required charge amount Hd from the storage unit 19, calculates the difference between the charge amount Hd and the residual capacity H0, and plans a charging schedule to reach the charge amount Hd by the departure date and time, using the electric fee prediction data in the electric fee table 7a, in the same manner as the above Embodiment 1.

After this, the charging schedule processing unit 8a transmits an instruction for instructing a charging control in accordance with the charging schedule planned as mentioned above to the charging/discharging controller 11 via the vehicle control unit 23 and the communication unit 24. If the charging schedule is received from the charging schedule processing unit 8a via the communication unit 9, the charging/discharging controller 11 controls the converter 13, and performs the charging processing for the battery 27 in accordance with the corresponding charging schedule.

As described above, according to the present Embodiment 4, the navigation apparatus 15a is installed as an apparatus in the charge vehicle 3, and includes: the electric fee table 7a in which data representing a change of an electric fee with the elapse of time of a system power 4 is set; the route calculation unit 16 that calculates a scheduled travel route to the destination based on the geographic data read from the geographic data base 17 and the position of the charge vehicle 3; the required charge amount calculation unit 22 that calculates the required charge amount Hd for the charge vehicle 3 to travel the scheduled travel route based on the travel distance of the scheduled travel route calculated by the route calculation unit 16 and a power consumption amount per unit travel distance of the battery 27 that is installed in the charge vehicle 3; and the charging schedule processing unit 8a that acquires the residual capacity H0 of the battery 27 installed in the corresponding charge vehicle 3, from the charge vehicle 3, plans a charging schedule to charge the battery 27 installed in the charge vehicle 3 from the residual capacity H0 of the battery 27 to the required charge amount Hd at the cheapest electric fee by the departure date and time, based on the electric fee table 7a, and causes the charging/discharging unit 10 that charges the battery 27 with the system power 4 to supply the system power 4 to the battery 27 in accordance with the corresponding charging schedule.

With the above configuration, the navigation apparatus 15a can set the scheduled travel route of the charge vehicle 3 and plan the charging schedule to control charging of the charge vehicle 3, therefore the charging schedule to charge the battery 27 with sufficient power at the travel start and at the cheapest electric fee by the departure date and time can be planned. It is noted that since in Embodiment 4 the charging schedule processing unit 8a is provided on the charge vehicle 3 side, the charge vehicle 3 can be charged from any facility having the charging/discharging unit 10.

In addition, though in the above Embodiment 4 the charging/discharging unit 10 is installed in the home inside 2, the charging/discharging unit 10 may be installed in the charge vehicle 3 side.

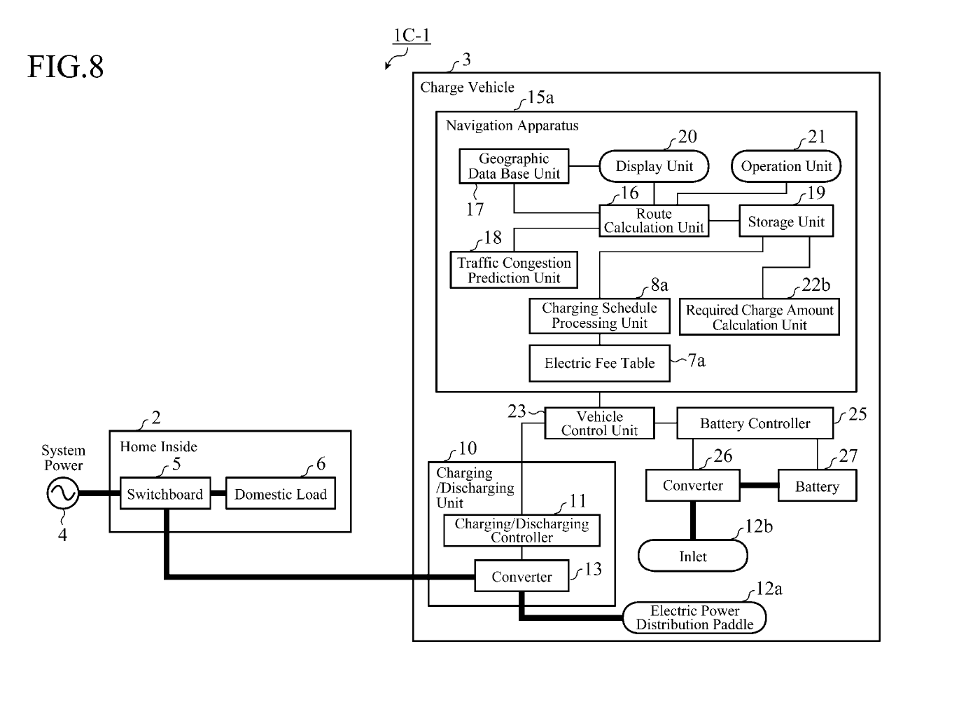

FIG. 8 is a block diagram showing a configuration of another mode of the charging control system in Embodiment 4. In FIG. 8, in a system configuration shown in FIG. 7, a charging control system 1C-1 is provided with the charging/discharging unit 10 installed in the charge vehicle 3, instead of the home inside 2. In the configuration, the charging schedule processing unit 8a outputs an instruction for instructing a charging control in accordance with the charging schedule to the charging/discharging controller 11 via the vehicle control unit 23. If the charging schedule from the charging schedule processing unit 8a is input via the vehicle control unit 23, the charging/discharging controller 11 controls the converter 13, and performs the charging processing for the battery 27 in accordance with the corresponding charging schedule. Since the charging/discharging unit 10 and the system power 4 can be connected to an AC outlet via a charging cable, the charging can be performed from any facility having an AC outlet.

### Embodiment 5

In Embodiment 5, a charging control apparatus in a home inside links with a navigation server apparatus that provides the same navigation function as the navigator apparatus 15 in the above Embodiment 1 via a network such as the Internet to thereby control the charging of the battery of a charge vehicle.

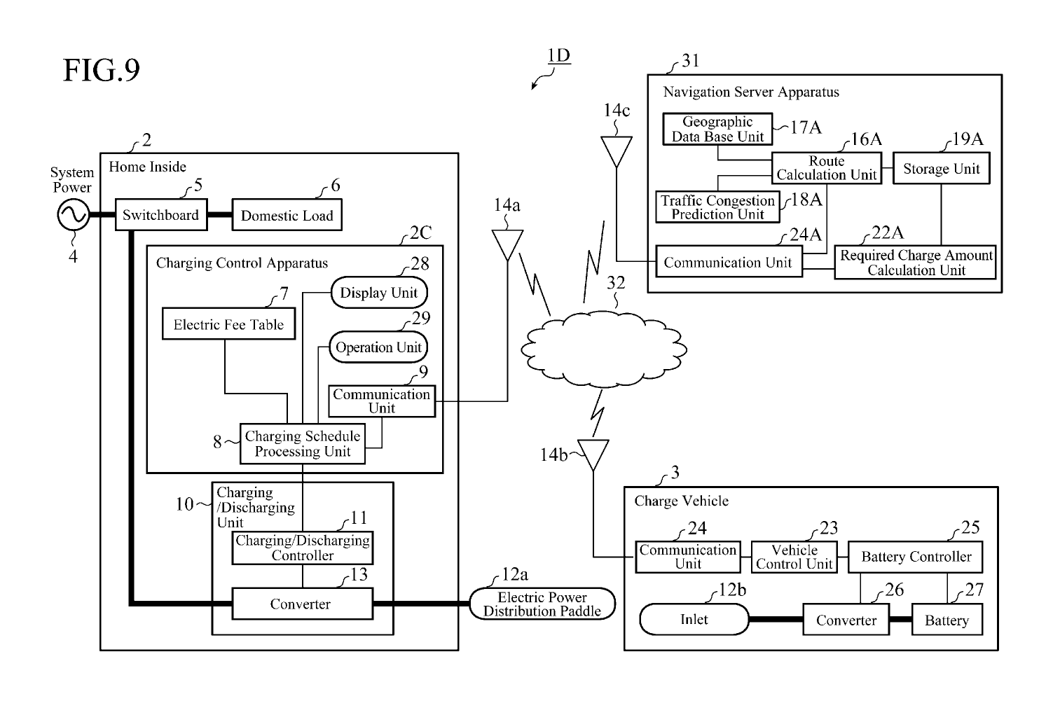

FIG. 9 is a block diagram showing a configuration example of a charging control system to which the charging control apparatus according to Embodiment 5 in the invention is applied. In FIG. 9, a charging control system 1D in Embodiment 5 has a configuration such that a charging control apparatus 2C in a home inside 2, a vehicle control unit 23 of a charge vehicle 3, and a navigation server apparatus 31 are interconnected via a network 32. However, in FIG. 9, components that are the same as or equivalent to those in FIGS. 1 and 5 are denoted by the same reference symbols, and descriptions thereof will be omitted. However, in FIG. 9, components that are the same as or equivalent to those in FIG. 1 and FIG. 5 are denoted by the same reference symbols, and descriptions thereof will be omitted.

The charging control apparatus 2C in the home inside 2 is an apparatus to control charging/discharging of a charging/discharging unit 10, and has an electric fee table 7, a charging schedule processing unit 8, a communication unit 9, a display unit 28 and an operation unit 29. The communication unit 9 is a constitutional part to communicate with the charge vehicle 3 and the navigation server apparatus 31 via the network 32. In other words, the communication unit 9 acquires a scheduled travel route of the charge vehicle 3, and a travel distance and travel time thereof from the navigation server apparatus 31 via the network 32, acquires a residual capacity H0 of a battery 27 from a vehicle control unit 23 of the charge vehicle 3 via the network 32, and acquires a required charge amount Hd from a required charge amount calculation unit 22A.

Based on the information on the residual capacity H0 of the battery 27 and the required charge amount Hd received by the communication unit 9, the charging schedule processing unit 8 plans a charging schedule to charge the battery 27 to the required charge amount Hd at the cheapest fee by a departure date and time of the charge vehicle 3 at, using the electric fee prediction data specified in the electric fee table 7.

The battery 27, which is a power source of the charge vehicle 3, the vehicle control unit 23, a communication unit 24, a battery controller 25 and a converter 26 are installed in the charge vehicle 3. The communication unit 24 is a constitutional part to communicate with the charging control apparatus 2C and the navigation server apparatus 31 via the network 32. In other words, the charge vehicle 3 transmits the required charge amount Hd of the vehicle to the charging control apparatus 2C by the communication unit 24 via the network 32, and requests the navigation server apparatus 31 to search a route, so as to acquire traffic congestion prediction data, a scheduled travel route of the vehicle, and travel distance and travel time thereof from the navigation server apparatus 31.

The navigation server apparatus 31 is a server apparatus to search a scheduled travel route for the charge vehicle 3 via the network 32, and has a route calculation unit 16A, a geographic data base unit 17A, a traffic congestion prediction unit 18A, a storage unit 19A, a required charge amount calculation unit 22A, and a communication unit 24A. If the charging control apparatus 2C requests the route calculation unit 16A to search for a scheduled travel route for the charge vehicle 3, the route calculation unit 16A searches for a scheduled travel route from a current position of the charge vehicle 3 to a destination based on the geographic data stored in the geographic data base unit 17A, and replies with the search result on the scheduled travel route and travel distance and travel time thereof to the charging control apparatus 2C using the communication unit 24A via the network 32. The traffic congestion prediction unit 18A determines the traffic congestion prediction data on the searched route, and transmits this data to the charging control apparatus 2C using the communication unit 24A via the network 32.

The geographic data base unit 17A is a data base to store geographic data. The geographic data base unit 17A is installed separately from the navigation apparatus described in Embodiment 4, hence a large capacity and more detailed geographic data can be registered compared with the case of being installed in the navigation apparatus. The traffic congestion prediction unit 18A is a constitutional part to predict a traffic congestion state of the road on the scheduled travel route of the charge vehicle 3 determined by the route calculation unit 16A. The required charge amount calculation unit 22A calculates a charge amount Hd required for traveling the corresponding route, based on the information on the scheduled travel route determined by the route calculation unit 16A, and transmits the value to the charging control apparatus 2C using the communication unit 24A via the network 32. The communication unit 24A is a constitutional part to communicate with the constitutional parts on the network 32 via an antenna 14c.

Next, an operation thereof will be described.

First, the charging control apparatus 2C provides an HMI for setting a route of the charge vehicle 3. In other words, the charging schedule processing unit 8 of the charging control apparatus 2C displays a route setting screen of the charge vehicle 3 on the display unit 28. Based on this route setting screen, the user inputs a departure date and time, a departure place (current position of the charge vehicle 3), and a destination using the operation unit 29. Then the communication unit 9 establishes the connection for communication with the communication unit 24A of the navigation server apparatus 31.

Subsequently, the charging schedule processing unit 8 transmits a request to search a route, including the departure place and the destination for the charge vehicle 3, to the navigation server apparatus 31 via the communication unit 9. If the request to search a route for the charge vehicle 3 is received from the charging control apparatus 2C via the communication unit 24A, the route calculation unit 16A of the navigation server apparatus 31 searches for a scheduled travel route specified by the departure place and the destination included in this request, and stores the scheduled travel route of the searched result, the travel distance and travel time thereof in the storage unit 19A.

The traffic congestion prediction unit 18A predicts the traffic congestion state of the scheduled travel route based on the past traffic congestion information that is held by the traffic congestion prediction unit 18A, and stores the traffic congestion prediction data indicating the traffic congestion state in the storage unit 19A.

Further, the required charge amount calculation unit 22A calculates the power consumption amount required for the travel on the corresponding route based on the travel distance of the scheduled travel route read from the storage unit 19A and the average power consumption amount of the vehicle.

Subsequently, the required charge amount calculation unit 22A corrects the calculated power consumption amount according to the road conditions that are predicted based on the departure date and time set by the user (e.g. traffic congestion prediction data on the departure date and time received from the server apparatus 31), in the same manner as the above Embodiment 1, and calculates the charge amount Hd required for the travel on the corresponding route.

Thereafter, the route calculation unit 16A transmits the information on the scheduled travel route stored in the storage unit 19A and the traffic congestion prediction data to the charging control apparatus 2C via the communication unit 24A, and the required charge amount calculation unit 22A transmits the required charge amount Hd to the charging control apparatus 2C via the communication unit 24A.

Then the communication unit 9 establishes a connection for communication with the communication unit 24 of the charge vehicle 3. Then the charging schedule processing unit 8 inquires the vehicle control unit 23 on the current residual capacity H0 of the battery 27 via the communication unit 9. Responding to this inquiry from the charging schedule processing unit 8 received via the communication unit 24, the vehicle control unit 23 acquires the residual capacity H0 of the battery 27 from the battery controller 25, and transmits the value to the charging control unit 2C via the communication unit 24. The charging schedule processing unit 8 acquires the residual capacity H0 of the battery 27 via the communication unit 9.

Subsequently, if the departure date and time, travel distance of the scheduled travel route, travel time on the route and required charge amount Hd are acquired from the navigation server apparatus 31 and if the current residual capacity H0 of the battery 27 is acquired from the charge vehicle 3, the charging schedule processing unit 8 calculates a difference between the required charge amount Hd and the current residual capacity H0, and plans a charging schedule to reach the charge amount Hd by the departure date and time, using the electric fee prediction data in the electric fee table 7, in the same manner as the above Embodiment 1.

After this, the charging schedule processing unit 8 transmits an instruction for instructing a charging control according to the charging schedule planned as mentioned above to the charging/discharging unit 10. The charging/discharging controller 11 of the charging/discharging unit 10 performs the charging processing for the battery 27 of the charge vehicle 3 in accordance with the above charging schedule by controlling the converter 13 based on the instruction from the charging schedule processing unit 8.

As described above, according to Embodiment 5, the charging control apparatus 2C in the home inside 2 includes: the communication unit 9 that performs communication between the navigation server apparatus 31 and the communication unit 24 installed in the charge vehicle 3; the electric fee table 7; and the charging schedule processing unit 8. With the above configuration, the charging control apparatus 2C in the home inside 2 and the navigation server apparatus 31 can cooperate with each other, and plan a charging schedule to charge the battery 27 with sufficient power at the travel start and at the cheapest electric fee by the departure date and time. Further, the processing load required for planning the charging schedule can be dispersed.

In the above Embodiment 5, shown is the case where the charging control apparatus 2C in the home inside 2, the charge vehicle 3 and the navigation server apparatus 31 are intercommunicated with each other via the network 32 such as the Internet; however, communication as shown in the following (a) to (c) may also be used.

(a) The charging control apparatus 2C in the home inside 2 and the navigation server apparatus 31 are communication-connected (Internet-connected) to the network 32 by cable, instead of the wireless connection via the antennas 14a and 14c and the communication units 9 and 24A, and the charging control apparatus 2C and the charge vehicle 3 are wireless-connected via the antennas 14a and 14b and the communication units 9 and 24.

(b) The charging control apparatus 2C and the charge vehicle 3 are communication-connected by PLC, instead of the antennas 14a and 14b and the communication units 9 and 24.

(c) The charging control apparatus 2C in the home inside 2 and the navigation server apparatus 31 are communication-connected by PLC via the system power 4, instead of the antennas 14a and 14c and the communication units 9 and 24A.

### Embodiment 6

According to Embodiment 6, a charging/discharging unit in a home inside is linked with a navigation server apparatus that manages a geographic data base and a charging control server apparatus via a network to thereby control in charging the battery of a charge vehicle.

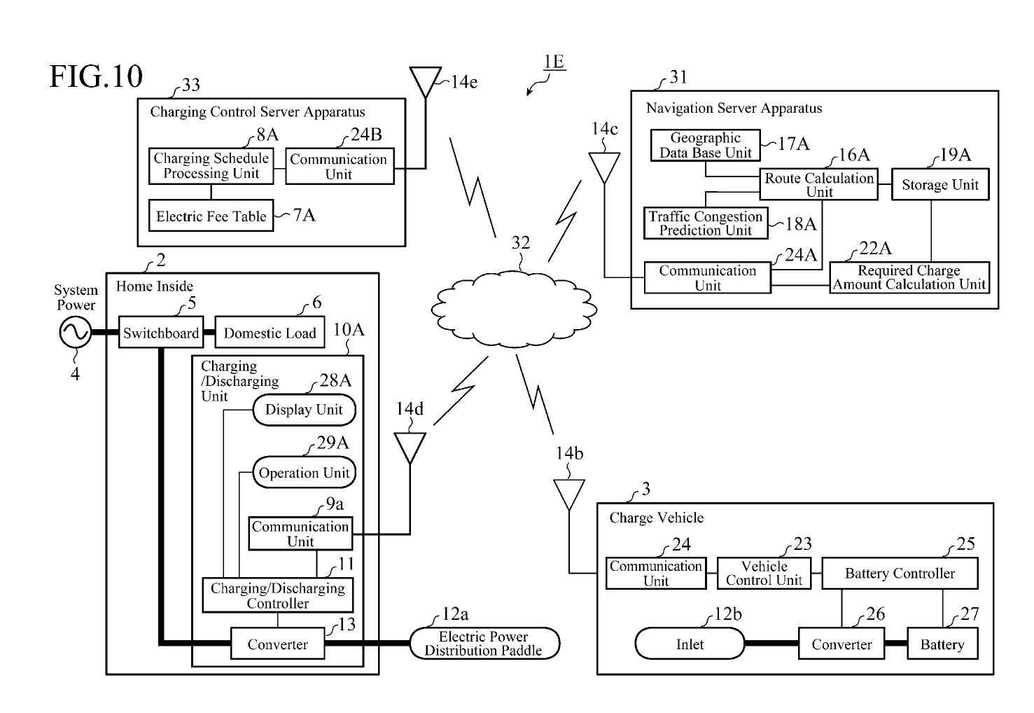

FIG. 10 is a block diagram showing a configuration of a charging control system to which a charging control apparatus according to Embodiment 6 in the invention is applied. In FIG. 10, a charging control system 1E in Embodiment 6 has a configuration such that a charging/discharging unit 10A in the home inside 2, a vehicle control unit 23 of a charge vehicle 3, a navigation server apparatus 31 and a charging control server apparatus 33 are interconnected via a network 32. However, in FIG. 10, components that are the same as or equivalent to those in FIG. 1 and FIG. 9 are denoted by the same reference symbols, and descriptions thereof will be omitted.

The charging/discharging unit 10A in the home inside 2 is a constitutional part to supply the power of the system power 4 to the charge vehicle 3 via the electric power distribution paddle 12a or supply the power from the charge vehicle 3 to the home inside 2 to the contrary.

In addition, the charging/discharging unit 10A has a display unit 28A and an operation unit 29A, and provides an HMI for route setting that sets a departure date and time and a destination of the charge vehicle 3. Specifically, the charging/discharging unit 10A transmits the departure date and time and the destination that are set by the user through the HMI for route setting to the navigation server apparatus 31 to be route-searched, and transmits the route searched result to the charging control server apparatus 33 to plan the charging schedule. If the charging schedule planned by the charging control server apparatus 33 is received via the communication unit 9a, the charging/discharging unit 10A executes the charging processing for the battery 27 of the charge vehicle 3 in accordance with the charging schedule.

The charging control server apparatus 33 has an electric fee table 7A, a charging schedule processing unit 8A and a communication unit 24B. The communication unit 24B is a constitutional part to communicate via an antenna 14e. That is, the communication unit 9a acquires the scheduled travel route of the charge vehicle 3, the travel distance, the travel time, the residual capacity H0 of the battery 27 and the required charge amount Hd via the network 32.

The charging schedule processing unit 8A plans a charging schedule for charging the battery 27 to the required charge amount Hd at the cheapest fee by the departure date and time of the charge vehicle 3, using information that indicates the residual capacity H0 of the battery 27 and the required charge amount Hd received by the communication unit 24B, and the electric fee prediction data specified from the electric fee table 7A.

Next, an operation thereof will be described.

### (1) Operation of Charging/Discharging Unit 10A

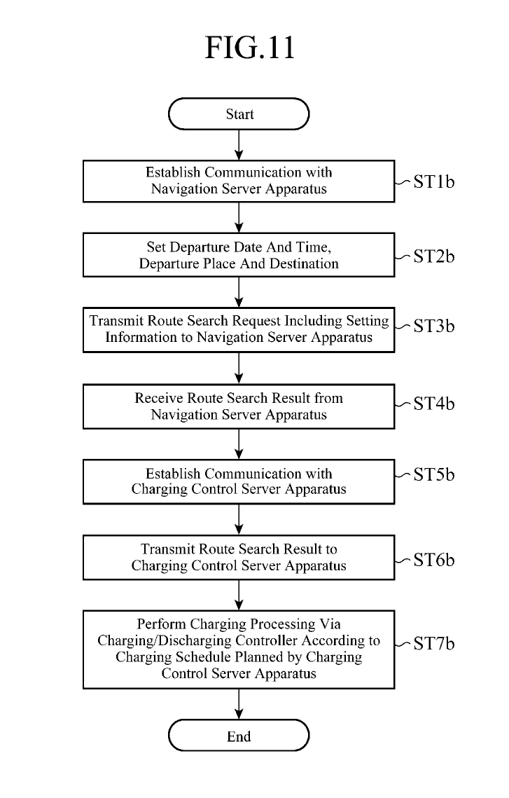

FIG. 11 is a flow chart showing a flow of processing by the charging/discharging unit in Embodiment 6.

First, the communication unit 9a of the charging/discharging unit 10A establishes a connection for communication with the navigation server apparatus 31 (step ST1b).

Then, a charging/discharging controller 11 of the charging/discharging unit 10A provides an HMI for route setting of the charge vehicle 3. Specifically, the charging/discharging controller 11 displays a route setting screen of the charge vehicle 3 on the display unit 28A. Based on the route setting screen, a user inputs a departure date and time, a departure place (current position of the charge vehicle 3), and a destination using the operation unit 29A (step ST2b).

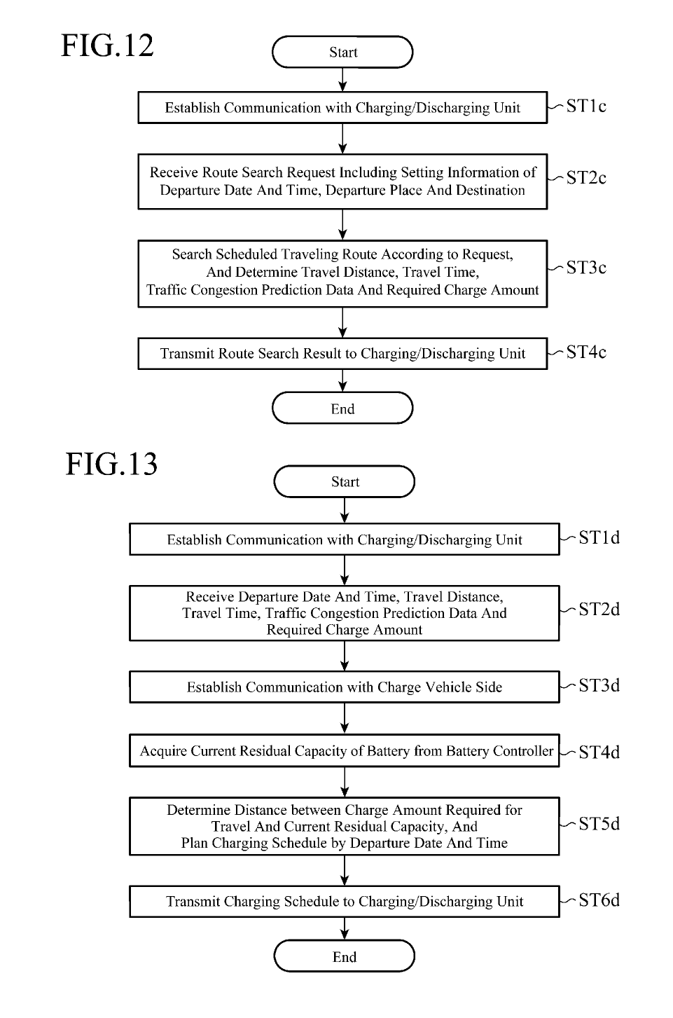

The charging/discharging controller 11 transmits a route search request including the above setting information to the navigation server apparatus 31 via the communication unit 9a (step ST3b). In the navigation server apparatus 31, the scheduled travel route of the charge vehicle 3 is searched, and the traffic congestion prediction data and the required charge amount Hd are calculated by the processing described later with reference to FIG. 12. The charging/discharging controller 11 receives the route searched result from the navigation server apparatus 31 via the communication unit 9a (step ST4b).

Subsequently, the communication unit 9a establishes the connection for communication with the charging control server apparatus 33 (step ST5b), and the charging/discharging controller 11 transmits the route searched result to the charging control server apparatus 33 via the communication unit 9a (step ST6b). Thereafter, the charging control server apparatus 33 plans a charging schedule by the processing described later with reference to FIG. 13. The charging/discharging controller 11 performs the charging processing for the battery 27 of the charge vehicle 3 in accordance with the charging schedule received from the charging control server apparatus 33 via the communication unit 9a (step ST7b).

### (2) Operation of Navigation Server Apparatus 31

FIG. 12 is a flow chart showing a flow of processing by the navigation server apparatus in Embodiment 6. First, the communication unit 24A of the navigation server apparatus 31 establishes the connection for communication with the charging/discharging unit 10A (step ST1c). Then, the communication unit 24A receives a route search request that includes the setting information of the departure date and time, the departure place and the destination from the charging/discharging unit 10A (step ST2c).

The route calculation unit 16A searches the scheduled travel route defined by the departure place and the destination, using the geographic data read from the geographic data base unit 17A, and stores the scheduled travel route of the searched result, and the travel distance and the travel time thereof in the storage unit 19A.

Also, the traffic congestion prediction unit 18A predicts the traffic congestion state of the scheduled travel route based on the past traffic congestion information that is held by itself, and stores the traffic congestion prediction data indicating the traffic condition state in the storage unit 19A.

Further, the required charge amount calculation unit 22A calculates the power consumption amount required for the travel on the route based on the travel distance of the scheduled travel route read from the storage unit 19A and the average power consumption amount of the vehicle.

Subsequently, the required charge amount calculation unit 22A corrects the power consumption amount of the calculated result according to the road conditions that are predicted based on the departure date and time set by the user (e.g. traffic congestion prediction data on the departure date and time), in the same manner as the above Embodiment 1, and calculates the charge amount Hd required for the travel on the corresponding route. The processing thus far corresponds to step ST3c.

Thereafter, the route calculation unit 16A transmits the information about the scheduled travel route stored in the storage unit 19A and the traffic congestion prediction data to the charging/discharging unit 10A via the communication unit 24A, and the required charge amount calculation unit 22A transmits the required charge amount Hd to the charging/discharging unit 10A via the communication unit 24A.

### (3) Operation of Charging Control Server Apparatus

FIG. 13 is a flow chart showing a flow of processing by the charging control server apparatus in Embodiment 6. First, the communication unit 24B of the charging control server apparatus 33 establishes a connection for communication with the charging/discharging unit 10A (step ST1d). Then, the communication unit 24B receives the departure date and time, travel distance, travel time, traffic congestion prediction data and required charge amount Hd as information about the scheduled travel route from the charging/discharging unit 10A (step ST2d).

Subsequently, the communication unit 24B establishes a connection for communication with the vehicle control unit 23 of the charge vehicle 3 (step ST3d). Thereafter, the charging schedule processing unit 8A inquires the current residual capacity H0 of the battery 27 to the vehicle control unit 23 via the communication unit 24B. Responding to the inquiry from the charging schedule processing unit 8A received via the communication unit 24, the vehicle control unit 23 acquires the residual capacity H0 of the battery 27 from the battery controller 25, and transmits the resultant to the charging control server apparatus 33 via the communication unit 24. The charging schedule processing unit 8A acquires the residual capacity H0 of the battery 27 via the communication unit 24B (step ST4d).

Next, if the departure date and time, the travel distance of the scheduled travel route, the travel time on the corresponding route, the required charge amount Hd and the current residual capacity H0 of the battery 27 are acquired, the charging schedule processing unit 8A calculates the difference between the required charge amount Hd and the current residual capacity H0, and plans a charging schedule to reach the charge amount Hd by the departure date and time, using the electric fee prediction date in the electric fee table 7A, in the same manner as the above Embodiment 1 (step ST5d).

After this, the charging schedule processing unit 8A transmits an instruction for instructing a charging control in accordance with the above charging schedule to the charging/discharging unit 10A via the communication unit 24B (step ST6d). The charging/discharging controller 11 of the charging/discharging unit 10A performs the charging processing for the battery 27 of the charge vehicle 3 in accordance with the corresponding charging schedule by controlling the converter 13 based on the instruction from the charging schedule processing unit 8A received via the communication unit 9a.

As described above, according to Embodiment 6, the charging control apparatus includes: the navigation server apparatus 31 having the geographic data base unit 17A, the route calculation unit 16A and the required charge amount calculation unit 22A; the charging control server apparatus 33 having the electric fee table 7A and the charging schedule processing unit 8A; and the charging/discharging unit 10A having the communication unit 9a that performs communication among the charge vehicle 3, the navigation server apparatus 31, the charging control server apparatus 33, and the charging/discharging controller 11 that supplies the system power 4 to the battery 27 in accordance with the charging schedule acquired from the charging control server apparatus 33 via the communication unit 9a.

With the above configuration, the charging/discharging unit 10A in the home inside 2, the navigation server apparatus 31 and the charging control server apparatus 33 can cooperate with each other, and plan a charging schedule to charge the battery 27 with sufficient power at the travel start and at the cheapest electric fee by the departure date and time. Further, the processing load required for planning the charging schedule can be dispersed, in the same manner as the above Embodiment 5.

Incidentally, in the above Embodiment 6, as a more preferable configuration, it is considered as follows: ID information or a password that identifies an authorized user who can receive the corresponding service is transmitted from the charging/discharging unit 10A to the navigation server apparatus 31, and the corresponding service is provided at the time when the user is authenticated on the navigation apparatus 31.

In the above Embodiment 6, shown is the case where the charging/discharging unit 10A in the home inside 2, the charge vehicle 3, the navigation server apparatus 31 and the charging control server apparatus 33 are intercommunicated with each other via the network 32 such as the Internet; however, communication as shown in the following (a) to (c) may also be used.

(a) The charging/discharging unit 10A in the home inside 2, the navigation server apparatus 31 and the charging control server apparatus 33 are communication-connected (Internet-connected) to the network 32 by cable, instead of the wireless connection via the antennas 14d, 14c and 14e and the communication units 9a, 24A and 24B.

(b) The charge vehicle 3 and the charging/discharging unit 10A are communication-connected by PLC, instead of the antennas 14b and 14d and the communication units 24 and 9a.

(c) The charging/discharging unit 10A in the home inside 2 and at least one of the navigation server apparatus 31 and the charging control server apparatus 33 are communication-connected by PLC via the system power 4.

### Embodiment 7

In the above Embodiments 1 to 6, the electric fee table is a predetermined fixed rate electric fee table, but the present Embodiment 7 has a function to update an electric fee table by inputting information that indicates a supplied electric fee from a switchboard.

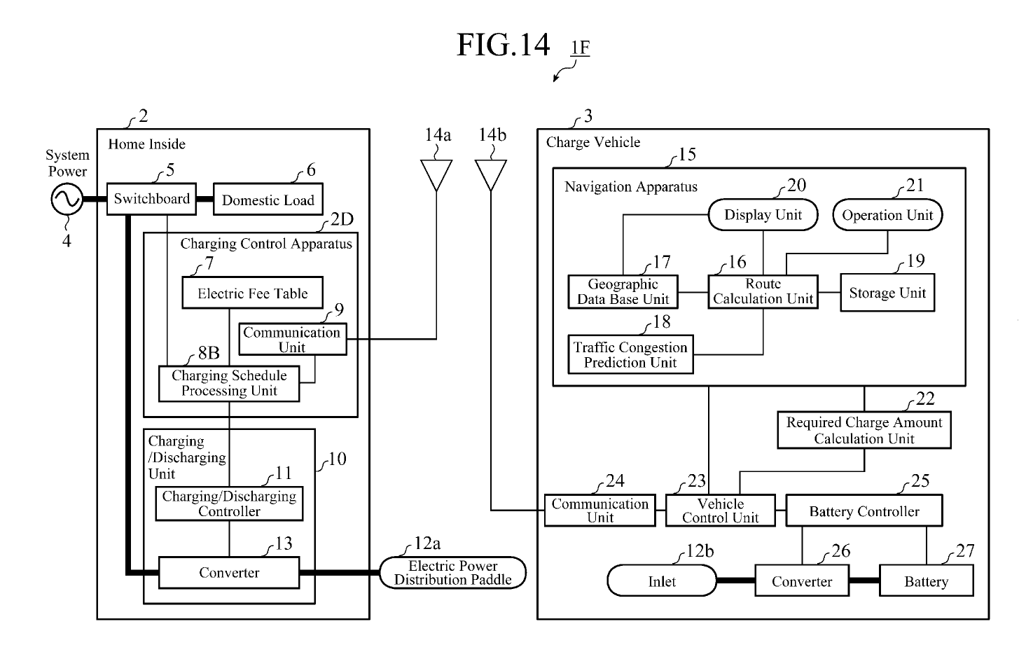

FIG. 14 is a block diagram showing a configuration of a charging control system to which a charging control apparatus according to Embodiment 7 in the invention is applied, and components that are the same as or equivalent to those in FIG. 1 is denoted by the same reference symbols, and descriptions thereof will be omitted. In FIG. 14, a charging control system 1F in Embodiment 7 has a similar configuration as that of the above Embodiment 1, but differs therefrom in that the charging schedule processing unit 8B in the charging control apparatus 2D of the home inside 2 inputs information that indicates an electric fee in real-time from the switchboard 5, and the values of an electric fee table 7 are updated based on the information. It is noted that the switchboard 5 and the charging schedule processing unit 8B are connected by power line communication (PLC), for instance.

For the information that indicates the electric fee in real-time, the electric fee information (supplied electric fee according to a period of time) is provided via the switchboard 5, in addition to a power consumption amount of the system power 4 for each time. The charging schedule processing unit 8B acquires information that indicates the corresponding electric fee from the switchboard 5 using power line communication, and updates the electric fee table 7.

Hereupon, shown is the case where the electric fee table 7 is updated using the information that indicates the supplied electric fee acquired from the switchboard 5 by power line communication, but the present invention is not limited to this mode. For example, an operation unit may be installed in the charging control apparatus 2D, such that the charging schedule processing unit 8B updates the electric fee table 7 based on the information that indicates the supplied electric fee that is input by an user using the corresponding operation unit.

Next, an operation thereof will be described.

Hereupon, in the case where the supplied electric fee prediction data of the electric fee table 7 and the electric fee in real-time are different from each other, processing in which the charging schedule processing unit 8B changes the values at the electric fee table 7 to an electric fee in real-time will be described.

### (1) Charging Control 1

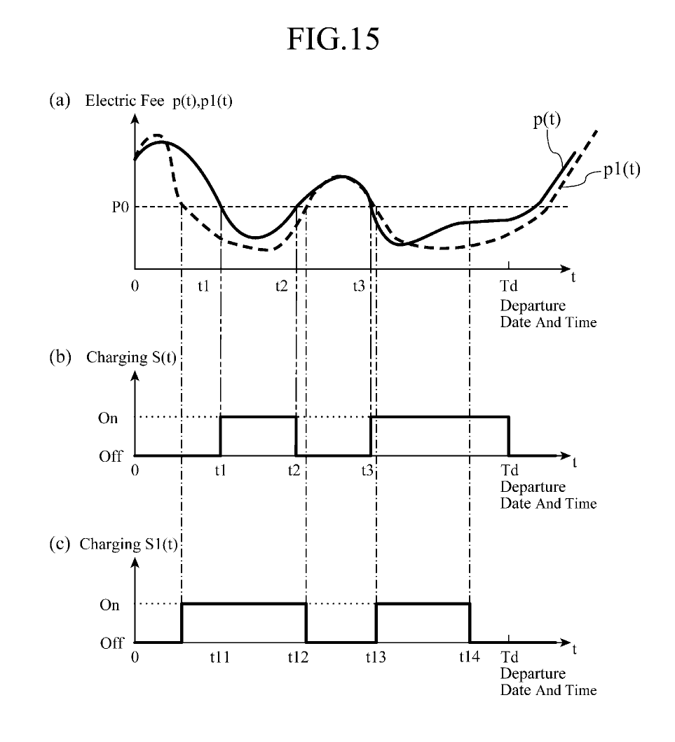

FIG. 15 is a graph for illustrating a charging control 1 according in Embodiment 7, where FIG. 15(a) shows electric fee data, FIG. 15(b) shows a charging ON/OFF control signal that is output in accordance with a charging schedule determined in the same manner as the above Embodiment 1, and FIG. 15(c) shows a charging ON/OFF control signal in the charging control 1.

First, in the same manner as the above Embodiment 1, the charging schedule processing unit 8B sets a threshold P0 serving as a reference to turn ON/OFF the charging based on a supplied electric fee prediction data curve p(t) in the electric fee table 7 that is indicated by a solid line in FIG. 15(a) and a departure date and time Td. If ON/OFF in the charging is controlled using the threshold P0, results in FIG. 15(b) or similar to FIG. 4(b) are acquired.

In the charging control 1, the charging schedule processing unit 8B sequentially updates the electric fee table 7 by a supplied electric fee in real-time from the charging processing start time (current time t=0), using the information that indicates the supplied electric fee to be acquired in real-time from the switchboard 5. In this manner, a supplied electric fee data curve p1(t) indicated by a broken line in FIG. 15(a) is acquired.

The charging schedule processing unit 8B plans a charging schedule to perform the charging, when the electric fee in real-time (fee indicated by the broken curve line p1(t) ) is cheaper than the predicted electric fee (fee indicated by the solid curve line P(t)), that is, p1(t)≦P0, from the start time of the charging processing (current time t=0). In this way, the time-dependent change of the charging ON/OFF control signal shown in FIG. 15(c) is acquired. In this case, when t11≦t<t12 and t13≦t<X are established, the charging control signal S1 (t)=1 or turns ON, and the charging time T becomes T=(t12−t11)+(X−t13). Therefore, the charging control signal S1 (t)=0 at time t14=X and later, that is, the processing is ended.

As stated above, when the electric fee table 7 is updated by the electric fee in real-time, the charging can be performed more quickly if the electric fee in real-time is cheaper than the predicted electric fee, and the fee required for the charging can be cheaper as compared with the above Embodiment 1.

### (2) Charging Control 2

Also, there may be provided a configuration that performs the following charging control.

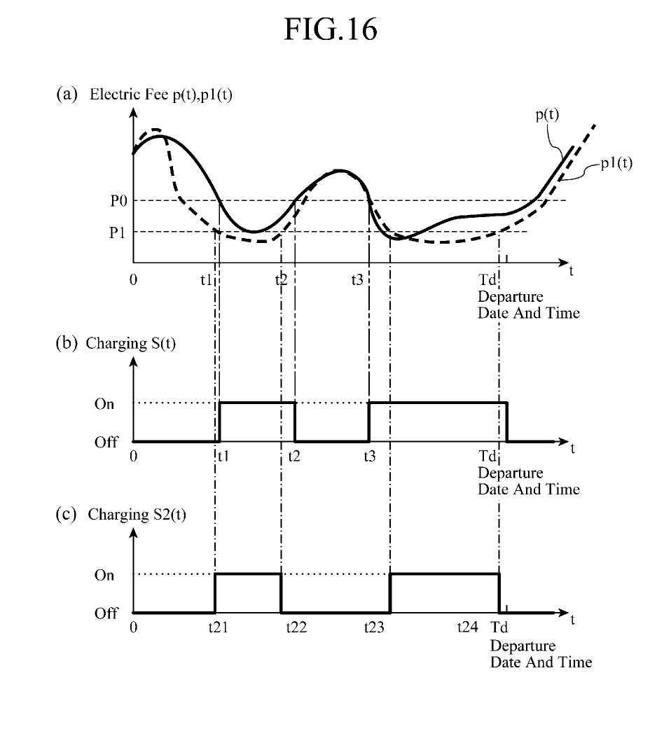

FIG. 16 is a graph for illustrating the charging control 2 in Embodiment 7, where FIG. 16(a) shows electric fee data, FIG. 16(b) shows a charging ON/OFF control signal that is output in accordance with a charging schedule determined in the same manner as the above Embodiment 1, and FIG. 16(c) shows a charging ON/OFF control signal in the charging control 2.

First, in the same manner as the above Embodiment 1, the charging schedule processing unit 8B sets a threshold P0 serving as a reference to turn ON/OFF the charging, based on a prediction data curve p(t) of the supplied electric fee in the electric fee table 7 that is indicated by a solid line in FIG. 16(a), and a departure date and time Td. If the charging ON/OFF is controlled using the threshold P0, results in FIG. 16(b) or similar to FIG. 4(b) are acquired.

Also, in the same manner as the charging control 1, the charging schedule processing unit 8B sequentially updates the electric fee table 7 by a supplied electric fee in real-time from the charging processing start time (current time t=0), using the information that indicates the supplied electric fee to be acquired in real-time from the switchboard 5. In this manner, the supplied electric fee data curve p1 (t) indicated by a broken line in FIG. 16(a) is acquired.

Generally, as the threshold serving as the reference to turn ON/OFF the charging is higher, the electric fee required for the charging is more expensive, but a period of time when the electric fee is the threshold or less is increased accordingly; thus, the probability is high that the charging processing will be completed within a predetermined period of time. On the other hand, if the threshold is lower, the electric fee required for the charging is cheaper, but the period of time when the electric fee is the above threshold or less is decreased accordingly; thus, the probability is low that the charging will be completed within a predetermined period of time.

Therefore, in the charging control 2, a value P1 that is lower than the above P0 by a predetermined value is set as the threshold serving as the reference to turn ON/OFF the charging. Hereupon, it is assumed that the charging of the charge amount Hd is not completed by the departure date and time Td if the charging is continued at an electric fee of the threshold or less from the current time t=0, but in a period from a predetermined point of time before the departure date and time Td to the departure date and time T, the charging of the charge amount Hd is completed in a period from the corresponding predetermined point of time to the departure date and time Td if the charging is continued, regardless of the above threshold, that is, regardless of the electric charge; in such a case, the threshold in which the total of the electric fee required for charging the battery 27 to the charge amount Hd is the cheapest is set as P1.

In the case of FIG. 16(c), the period T1 where the charging is performed at an electric fee of the threshold P1 or less from the current time t=0 is T1=(t22−t21)+(t24−t23), and the period T1 and the charging time T required for charging to the charge amount Hd are in the relationship of T1≦T. For this reason, the charging is not completed at the point of time when the period T1 elapses from the current time t=0.

In this case, if the charging is stopped simply because the electric fee exceeds the threshold P1, the charging is not completed by the departure date and time Td; however, the time t30 is determined such that the charging is completed before the departure date and time Td if the charging is continued regardless of the threshold P1, and the charging control signal S2 (t)=1, that is, the charging is turned ON from the time t30 onward.

When the time t30 is defined as a period T3 such that the charging ON is continued after the corresponding time t30, T3 is expressed as T3=∫s2(t)dt (0≦t<t30), and the charging time T satisfies T=T3+Td−t30. When a charging schedule that performs the above charging control is planned, the battery 27 can be charged with sufficient power at the travel start and at an inexpensive electric fee by the departure date and time.

Incidentally, in the above description, shown is the case where the threshold of the electric fee is fixed; however, the threshold P1 may be a time-dependent variable only if it enables to charge the battery 27 with sufficient power at the travel start and at an inexpensive electric fee by the departure date and time.

Also, it may be controlled so that the charging is completed by a predetermined time before the departure date and time in order to allow for some leeway.

As described above, according to the present Embodiment 7, the charging schedule processing unit 8B updates the electric fee table 7 by an electric fee in real-time of the system power 4. By doing so, if the electric fee in real-time is cheaper than the predicted electric fee, the charging can be performed more quickly, and the fee required for the charging can be cheaper as compared with the above Embodiment 1.

Incidentally, in the above Embodiment 7, shown is the case where the charging is performed when p1 (t)≦P0; however, the charging may be performed in p1 (t)≦P0 or p (t)≦P0, and the charging may be ended at the point of time when the total charging time becomes T.

Further, according to the above Embodiment 7, in the case where the charging of the battery 27 is continued at the cheapest electric fee based on the sequentially updated electric fee table 7, the charging of the battery 27 to the required charge amount cannot be performed by the departure date and time Td, the charging schedule processing unit 8B plans a charging schedule to continue the charging regardless the electric fee so that the charging of the battery 27 to the required charge amount Hd is completed by the departure date and time Td. By doing so, the battery 27 can be charged with sufficient power at the travel start and at the cheapest electric fee by the departure date and time.

Incidentally, in the above Embodiment 1 to Embodiment 7, shown the case where the charging/discharging unit 10 performs a dielectric type power supply to the charge vehicle 3 side, but DC power may be supplied by direct plug-in. Also, a feeding configuration by an ordinary power supply system in the home inside 2, for example, AC 100V or 200V, may be employed. This is selected according to the charging system of an EV or HEV that is a charging subject.

In addition, in the above Embodiment 1 to Embodiment 7, shown is the case where the battery 27 of the charge vehicle 3 is charged using the system power 4 connected in the home inside 2, but the present invention may be applied to a power supply station having a parking lot and so on, instead of the home inside 2.

Further, in the above Embodiment 1 to Embodiment 7, the user may be authenticated between the vehicle side and the power supply side. To authenticate the user, a key of the vehicle or a smart key installed in a portable telephone, a vehicle number stored in the vehicle, a password, an apparatus number of the navigation apparatus, bio-authentication or the like can be used. For example, when an authentication of the user is carried out upon communication by the communication units, theft of electricity can be prevented.

Further, in the above Embodiment 1 to Embodiment 7, shown is the case where the power is supplied from the system power 4 side to the charge vehicle 3 in only one direction; however, the charging schedule processing unit may plan a charging schedule such that the battery 27 is charged in a period of time when the electric fee is a predetermined threshold or less (late-night rate cheaper than the daytime), and the power from the battery 27 to the system power 4 side is supplied in a period of time when the electric fee is high and exceeds the predetermined threshold (high rate during the daytime), and therefore it may be configured that a charging control is performed in accordance with the resultant schedule.

Incidentally, charging/discharging characteristics of the battery may differ depending on its type and/or an individual difference thereof.

Therefore, in the above Embodiment 1 to Embodiment 7, information that indicates the charging/discharging characteristics may be registered in the charging schedule processing unit corresponding with a model of the vehicle or a model number of the battery.

In this case, when the user sets in the charging schedule processing unit the model of the vehicle or the model number of the battery to be assumed as a processing subject for the charging using the operation unit and the like, the charging schedule processing unit plans a charging schedule considering the charging characteristics of the battery. By doing so, an efficient control corresponding to the charging characteristics of the battery is possible. It is noted that the information that indicates the charging/discharging characteristics of the battery may be registered in a server apparatus that is communication-connected with the ECU of the vehicle or the charging schedule processing unit with corresponding with the model of the vehicle or the model number of the battery.

Further, in the above Embodiment 1 to Embodiment 7, the charge amount W per unit time is constant, but the charge amount W per unit time may be increased in a period of time falling into a cheaper electric fee. Specifically, if it is determined that from the supplied electric fee prediction data of the electric fee table, the electric fee is a period of time of a predetermined threshold or less (period of time when the electric fee is cheap), the charging schedule processing unit plans a charging schedule to increase a charge amount W per unit time as compared with that in a period of time corresponding to an expensive electric fee exceeding the above threshold.

Incidentally, it may be configured such that the charge amount W per unit time is increased if it is predicted that the charging is not completed by the departure date and time judging from the charging state. Specifically, the charging schedule processing unit sequentially acquires the charging state of the battery 27 via the vehicle control unit 23, and determines whether the charging is completed by the departure date and time or not. If it is predicted that the charging is not completed by the departure date and time, the charging schedule processing unit plans a new charging schedule such that the charging is completed by the departure date and time with increasing the charge amount W per unit time.

It is noted that when a conventional technique such as an increase of the voltage of the inverter (rapidly charging mode) is employed, the power amount per time can be controlled.

Further, in the above Embodiment 1 to Embodiment 7, for the charge amount Hd, the required charge amount calculation unit may work out a charge amount by adding a predetermined extra charge amount corresponding to a predetermined margin with respect to the charge amount required for the travel on the scheduled travel route.

Also, in the above Embodiment 1 to Embodiment 7, an interior apparatus (e.g. air conditioner) to be used may be predicted at the predicted temperature on the departure date and time, or an interior apparatus (e.g. audio apparatus) to be used may be predicted based on a period of time during a travel, and a charge amount Hd allowing for a power amount to be consumed by these apparatus may be set.

For example, the predicted power amount to be consumed by the air conditioner is stored in the storage unit 19 for each temperature range, and when the required charge amount calculation unit calculates the charge amount Hd, the temperature range is predicted from the departure date and time, the predicted power amount of the air conditioner corresponding to the temperature range is specified from the storage unit 19, and the charge amount Hd allowing for the predicted power amount is calculated.

Further, in the above Embodiment 1 to Embodiment 7, in the case where the charge vehicle 3 includes an air conditioner (cooler, heater, and so on) driven by the power stored in the battery 27, the air conditioner is operated from a predetermined time before the departure time and date so that the environment is moderately air conditioned by the departure date and time, the power amount to be used by the air conditioner between the corresponding predetermined time and the departure time may be included in the charge amount Hd to be set.

For example, the power consumption amount of the air conditioner per unit time is set in the required charge amount calculation unit in advance; if the activation timer of the air conditioner is set so that the conditioner is activated from a predetermined time before the departure date and time, the required charge amount calculation unit calculates the power amount to be consumed between the corresponding time and the departure date and time based on the power consumption amount per unit time of the air conditioner, and calculates the charge amount Hd allowing for the corresponding power amount.

Also, in the above Embodiment 1 to Embodiment 7, shown is the case where the required charge amount calculation unit calculates the charge amount Hd required for traveling the scheduled travel route; however, a predetermined level of charge amount that is close to but not exceeding the full charge of the battery 27 may be set as the charge amount Hd.

Further, the above Embodiment 1 to Embodiment 7, shown is the case where the traffic congestion prediction unit stores the traffic congestion prediction data in advance; however, traffic congestion prediction data or traffic congestion information may be acquired from an information providing apparatus that provides the traffic congestion data via the Internet, for example. Traffic congestion information of VICS® (Registered Trademark) may also be used.

Also, though the configuration of installing the charging/discharging unit on the vehicle side is shown as a mode related to the above Embodiment 4, the configuration of installing the charging/discharging unit on the vehicle side may be employed for the above Embodiments 1 to 3 and 5 to 7 as well. In this case, charging can be performed from any facility having an AC outlet.

It is noted that in the present invention, the embodiments can be freely combined with each other, any components of the embodiments can be modified, or any components of the embodiments can be omitted within the scope of the invention.

### INDUSTRIAL APPLICABILITY

Since the charging control apparatus of the present invention can charge sufficient power for the travel of the vehicle at a cheap electric fee, it is suitable for a charging facility such as an electric vehicle.

1. A charging control apparatus, comprising:
a communication unit that communicates with a vehicle;
an electric fee table in which data that indicates the change of an electric fee of a system power with the elapse of time is set; and
a charging schedule processing unit that acquires from the vehicle a residual capacity of a battery installed in the vehicle via the communication unit, plans a charging schedule to charge the battery installed in the vehicle from the residual capacity of the battery to a charge amount required for traveling to destination at the cheapest electric fee by a predetermined date and time, based on the electric fee table, and causes a charging/discharging unit that charges the battery with the system power to supply the system power to the battery in accordance with the corresponding charging schedule.

2. The charging control apparatus according to claim 1, further comprising:
a geographic data base that stores geographical data;
a route calculation unit that calculates a scheduled travel route to a destination based on a vehicle position and geographic data read from the geographic data base; and
a required charge amount calculation unit that calculates a required charge amount for the vehicle to travel the corresponding scheduled travel route based on a travel distance of the scheduled travel route calculated by the route calculation unit, and a power consumption amount of the battery per unit travel distance of the vehicle, wherein
the charging schedule processing unit requests the route calculation unit to search a route to a destination that is input using an operation unit to perform an input operation, such that the route calculation unit calculates a scheduled travel route to the destination, and also the required charge amount calculation unit calculates a required charge amount for the corresponding scheduled travel route, and acquires the residual capacity of the battery from the vehicle via the communication unit, and
the charging schedule processing unit plans a charging schedule for charging the battery installed in the vehicle from the residual capacity of the battery to the required charge amount at the cheapest electric fee by the travel start date and time of the vehicle based on the electric fee table.

3. The charging control apparatus according to claim 2, further comprising:
a traffic congestion prediction unit that predicts a traffic congestion state of the scheduled travel route from traffic congestion information indicating a traffic congestion state of a road in the past, wherein
the required charge amount calculation unit predicts a variation of the power consumption amount of the battery due to the traffic congestion of the scheduled travel route, based on the power consumption amount of the battery according to a traveling speed of the vehicle, and traffic congestion information indicating the traffic congestion state of the scheduled travel route predicted by the traffic congestion prediction unit, corrects the power consumption amount of the battery predicted for the travel on the scheduled travel route with the variation of the corresponding power consumption amount and calculates the required charge amount.

4. The charging control apparatus according to claim 2, wherein
the geographic data base stores geographic data including undulation information of roads, and
the required charge amount calculation unit predicts a variation of the power consumption amount of the battery according to a slope in undulation of the scheduled travel route, based on the power consumption amount of the battery according to the slope in undulation of the road and the undulation information in the roads of the scheduled travel route included in the geographic data read from the geographic data base, corrects the power consumption amount of the battery predicted for a travel on the scheduled travel route with the variation of the power consumption amount, and calculates the required charge amount.

5. The charging control apparatus according to claim 2, wherein
the geographic data base stores geographic data including classification information of roads, and
the required charge amount calculation unit predicts a variation of the power consumption amount of the battery according to a traveling speed of the vehicle, based on the power consumption amount of the battery according to the traveling speed of the vehicle and the traveling speed of the vehicle defined by the road classification of the scheduled travel route included in the geographic data read from the geographic data base, corrects the power consumption amount of the battery predicted for a travel on the scheduled travel route with the variation of the corresponding power consumption amount, and calculates the required charge amount.

6. The charging control apparatus according to claim 2, wherein
the required charge amount calculation unit predicts a power consumption amount of the battery by vehicle interior apparatus to be used at a predicted temperature or in a period of time of a predetermined date and time, corrects the power consumption amount of the battery predicted for a travel on the scheduled travel route with the corresponding power consumption amount, and calculates the required charge amount.

7. The charging control apparatus according to claim 1, wherein the vehicle further comprises:
a navigation apparatus having a geographic data base that stores geographic data, and a route calculation unit that calculates a scheduled travel route to a destination based on a vehicle position and the geographic data read from the geographic data base; and
a required charge amount calculation unit that calculates a required charge amount for the vehicle to travel the corresponding scheduled travel route, based on a travel distance of the scheduled travel route calculated by the route calculation unit, and a power consumption amount of the battery per unit travel distance of the vehicle, wherein
the charging schedule processing unit requests the vehicle, via the communication unit, to search a route to a destination that is input using an operation unit that performs an input operation, such that the route calculation unit calculates a scheduled travel route to the destination and also the required charge amount calculation unit calculates a required charge amount for the scheduled travel route, and acquires the required charge amount and the residual capacity of the battery from the vehicle via the communication unit, and
the charging schedule processing unit plans a charging schedule for charging the battery installed in the vehicle from the residual capacity of the battery to the required charge amount at the cheapest electric fee by the travel start date and time of the vehicle, based on the electric fee table.

8. The charging control apparatus according to claim 1, wherein the charging schedule processing unit updates the electric fee table in accordance with a real-time electric fee of the system power.

9. The charging control apparatus according to claim 8, wherein in the case where the required charge amount cannot be charged by the predetermined date and time when the charging of the battery is continued at the cheapest electric fee based on the electric fee table that is sequentially updated in accordance with the real-time electric fee of the system power, the charging schedule processing unit plans the charging schedule to continue the charging regardless the electric fee and complete the charging of the battery up to the required charge amount by the predetermined date and time.

10. The charging control apparatus according to claim 1, wherein
the charging/discharging unit supplies the system power to charge the battery, and also supplies power stored in the corresponding battery to the system power side, and
the charging schedule processing unit plans a charging schedule to charge the corresponding battery to the required charge amount at the cheapest electric fee by a predetermined date and time, such that the battery is charged in a period of time when the electric fee is a predetermined threshold or less, and also that power stored in the battery is supplied the to system power side in a period of time when the electric fee exceeds the predetermined threshold.

11. A charging control apparatus, comprising:
a communication unit that communicates between the vehicle and a server apparatus that includes a geographic data base that stores geographic data, a route calculation unit that calculates a scheduled travel route to a destination based on geographic data read from the geographic data base and a vehicle position, and a required charge amount calculation unit that calculates a required charge amount for the vehicle to travel the corresponding scheduled travel route, based on a travel distance of the scheduled travel route calculated by the route calculation unit and a power consumption amount of the battery installed in the corresponding vehicle per unit travel distance of the vehicle;
an electric fee table in which data indicating a change of an electric fee with the elapse of time of a system power is set; and
a charging schedule processing unit that acquires from the vehicle a residual capacity of the battery installed in the vehicle via the communication unit, acquires the required charge amount for the vehicle to travel the scheduled travel route from the server unit, plans a charging schedule to charge the battery installed in the vehicle from the residual capacity of the battery to the required charge amount at the cheapest electric fee by at predetermined date and time, based on the electric fee table, and causes a charging/discharging unit that charges the battery with the system power to supply the system power to the battery in accordance with the corresponding charging schedule.

12. A charging control apparatus installed in a vehicle, comprising:
a electric fee table in which data that indicates a change of an electric fee with the elapse of time of a system power is set;
a route calculation unit that calculates a scheduled travel route to a destination based on geographic data read from a geographic data base and the vehicle position;
a required charge amount calculation unit that calculates a required charge amount for the vehicle to travel the corresponding scheduled travel route, based on a travel distance of the scheduled travel route calculated by the route calculation unit and a power consumption amount of the battery installed in the vehicle per unit travel distance; and
a charging schedule processing unit that acquires from the vehicle a residual capacity of the battery installed in the corresponding vehicle, plans a charging schedule to charge the battery installed in the vehicle from the residual capacity of the battery to the required charge amount at the cheapest electric fee by a predetermined date and time, based on the electric fee table, and causes a charging/discharging unit that charges the battery with the system power to supply the system power to the battery in accordance with the corresponding charging schedule.

13. The charging control apparatus according to claim 12, wherein the charging/discharging unit is installed in the vehicle, and the charging schedule processing unit plans the charging schedule for the charging/discharging unit installed in the vehicle.

14. The charging control apparatus according to claim 12, further comprising:
a traffic congestion prediction unit that predicts a traffic congestion state of the scheduled travel route from traffic congestion information indicating a traffic congestion state of a road in the past, wherein
the required charge amount calculation unit predicts a variation of the power consumption amount of the battery due to the traffic congestion of the scheduled travel route, based on the power consumption amount of the battery according to a traveling speed of the vehicle, and traffic congestion information indicating the traffic congestion state of the scheduled travel route predicted for the traffic congestion prediction unit, corrects the power consumption amount of the battery predicted for the travel on the scheduled travel route with the variation of the corresponding power consumption amount, and calculates the required charge amount.

15. The charging control apparatus according in claim 12, wherein
the geographic data base stores geographic data including undulation information of roads, and
the required charge amount calculation unit predicts a variation of the power consumption amount of the battery due to a slope of the scheduled travel route, based on the power consumption amount of the battery according to the slope in height of the road and the undulation information in the roads of the scheduled travel route included in the geographic data read from the geographic data base, corrects the power consumption amount of the battery predicted for a travel on the scheduled travel route with the variation of the corresponding power consumption amount, and calculates the required charge amount.

16. The charging control apparatus according to claim 12, wherein
the geographic data base stores geographic data including classification information of roads, and
the required charge amount calculation unit predicts a variation of the power consumption amount of the battery according to a traveling speed of the vehicle, based on the power consumption amount of the battery according to the traveling speed of the vehicle and the traveling speed of the vehicle defined by the road classification of the scheduled travel route included in the geographic data read from the geographic data base, corrects the power consumption amount of the battery predicted for a travel on the scheduled travel route with the variation of the corresponding power consumption amount, and calculates the required charge amount.

17. The charging control apparatus according to claim 12, wherein the charging schedule processing unit updates the electric fee table in accordance with a real-time electric fee of the system power.

18. The charging control apparatus according to claim 12, wherein the required charge amount calculation unit predicts a power consumption amount of the battery consumed by vehicle interior apparatus operated before a predetermined date and time, corrects the power consumption amount of the battery predicted for a travel on the scheduled travel route with the corresponding power consumption amount, and calculates the required charge amount.
